(19) United States
(12) Patent Application Publication
(10) Pub. No.: US 2024/0209214 A1
(43) Pub. Date: Jun. 27, 2024

(54) METHODS OF ATTACHING AZIDE COMPOUNDS TO SURFACES AND COMPOUNDS AND PRODUCTS THEREOF

(71) Applicant: Vanderbilt University, Nashville, TN (US)

(72) Inventors: Bradley Alan Baker, Nashville, TN (US); Paul E. Laibinis, Nashville, TN (US)

(21) Appl. No.: 18/556,407

(22) PCT Filed: May 20, 2022
(86) PCT No.: PCT/US2022/072455

§ 371 Date: Oct. 20, 2023

Related U.S. Application Data
(60) Provisional application No. 63/191,032, filed on May 20, 2021.

(51) Int. Cl. C09C 3/08; C08J 7/16; C09C 1/28

(52) U.S. Cl. CPC C09C 3/08; C08J 7/16; C09C 1/28; C01P 2002/82

(57) ABSTRACT

The present disclosure provides for methods to attach an organic azide to an H-terminated group, products of the methods, structures including the moiety including an azide, sensors include the products and structure, methods of sensing, and the like. In an aspect, the method of attaching an organic azide to an H-terminated group can be achieved using a one-step approach, while in other aspects the method may include more than one step. The present disclosure provides for a process of attaching an organic azide molecule to a surface such as a non-porous or porous substrate including H-terminated groups such as the Si—H groups of a silicon surface by a covalent bond such as a silicon-carbon bond linkage.

### CROSS-REFERENCE TO RELATED APPLICATIONS

This application claims the benefit of and priority to U.S. Provisional Application Ser. No. 63/191,032, having the title “ONE-STEP ATTACHMENT OF 4-VINYLBENZYL AZIDE TO H-TERMINATED SILICON SURFACES FOR CLICK CHEMISTRY APPLICATIONS” filed on May 20, 2021, the disclosure of which is incorporated herein in by reference in its entirety.

### BACKGROUND

Once an alkyne or azide group has been attached to a desired substrate (e.g., nanoparticles, flat surfaces, porous surfaces, CNT's, fibers, polymer, etc.), a click reaction (e.g., copper(I)-catalyzed azide-alkyne cycloaddition (CuAAC) and copper-free click chemistry) can be an efficient strategy for introducing other functionalities, molecular species, biomolecules, and polymers with the corresponding azide or alkyne group to these solid supports/surfaces/materials. However, efficient and simple ways of attaching azide groups are desired.

### SUMMARY

The present disclosure provides for methods to attach an organic azide to H-terminated groups, products of the methods, structures including the moiety including an azide, sensors including the products and structure, methods of sensing, and the like.

The present disclosure provides for methods of attaching an organic azide to a H-terminated group. In an aspect, the method includes contacting a solution including the organic azide with the H-terminated group; and exposing the organic azide and the H-terminated group to an energy source, a catalyst, or a combination of the energy source and the catalyst, wherein the exposure results in the formation of a covalent bond between the organic azide and the H-terminated group to form a moiety including an azide. In an aspect, the H-terminated group is an H-terminated surface of a structure, wherein the exposure results in the formation of a covalent bond between the organic azide and the surface to form a moiety including an azide, wherein an azide moiety is attached to the surface. In another aspect, the H-terminated group is a H-terminated group of a molecule such as a polymer. The present disclosure also includes materials made from the methods described above and herein.

The present disclosure also includes materials comprising: a structure having a surface, wherein the surface includes structural surface Si atoms, wherein at least one structural surface Si is covalently bonded to a carbon or nitrogen or oxygen of a moiety including an azide.

The present disclosure also includes sensors comprising: the structure as described above and herein where an alkyne-containing molecule is reacted with the azide-containing structure using click chemistry to form a modified structure, wherein the modified structure including the alkyne-containing molecule includes a functional group capable of capturing or detecting a targeted molecule.

### BRIEF DESCRIPTION OF THE DRAWINGS

Further aspects of the present disclosure will be more readily appreciated upon review of the detailed description of its various embodiments, described below, when taken in conjunction with the accompanying drawings.

FIG. 1 illustrates a strategy for introducing surface-bound azide groups to a H-terminated silicon (Si) surface. VBA was irradiated with UV light to induce attachment to a freshly HF-etched silicon substrate. In a second step, a click chemistry reaction between the surface-bound azide and an alkyne was performed.

FIG. 2A illustrates average advancing contact angles of water on g-VBA surfaces with varying UV exposure time. FIG. 2B illustrates ellipsometric thickness change to the g-VBA samples in “a)” after click reaction with a PEG2000-alkyne.

FIGS. 3A and 3B illustrate comparison of g-VBA samples prepared via “dilute” preparation method (i.e., 10% v/v VBA in o-xylene) to those prepared from “neat” VBA (average values for “neat” samples denoted by dotted line). FIG. 3A illustrates average advancing contact angles of water on g-VBA surfaces with varying UV exposure time. FIG. 3B illustrates ellipsometric thickness change to the g-VBA samples in “a)” after click reaction with a PEG2000-alkyne.

FIG. 4 illustrates the comparison of the FTIR spectra of HF-etched porous silicon to VBA-modified porous silicon produced by 200 s exposure to UV with VBA.

FIG. 5 illustrates the comparison of the FTIR spectra of liquid VBA to VBA-modified porous silicon.

FIG. 6 illustrates the comparison of the FTIR spectra of VBA-modified porous silicon before and after click reaction with a PEG2000-alkyne.

FIGS. 7A and 7B illustrate the comparison of the FTIR spectra of VBA-modified porous silicon before and after click reaction with (FIG. 7A) benzaldehyde propargyl ether, 5-hexynoic acid (FIG. 7B), and SB-alkyne (FIG. 7C).

FIG. 8 illustrates the comparison of the FTIR spectra of VBA-modified porous silicon before and after click reaction with DBCO-PEG4-biotin.

FIG. 9A illustrates the NMR spectrum of 4-vinylbenzyl chloride (starting material). FIG. 9B illustrates the NMR spectrum of 4-vinylbenzyl azide (product).

FIG. 10 illustrates the FTIR spectrum of 4-vinylbenzyl azide.

FIG. 11 illustrates the FTIR spectra of 4-hydroxybenzaldehyde (starting material) and benzaldehyde proparygylether (product).

FIG. 12 illustrates the comparison of FTIR spectra of liquid 4-vinylbenzyl azide before and after 400 seconds of exposure to UV.

FIG. 13 illustrates the NMR spectrum of 4-vinylbenzyl azide after 400 seconds of exposure to UV.

FIG. 14 illustrates the comparison of FTIR spectra of an HF-etched porous silicon surface before and after VBA attachment. To assess durability in HF, this PSi-g-VBA sample was also exposed to a 2.5% aqueous HF solution for 5 minutes.

FIG. 15 illustrates the comparison of FTIR spectra of a PSi-g-VBA surface before and after click reaction with PEG2000-alkyne. FTIR spectra of PEG2000-alkyne powder is included for reference.

FIG. 16 illustrates the comparison of FTIR spectra of a PSi-g-VBA surface clicked with SB-alkyne and the product of the liquid phase click reaction of VBA and SB-alkyne.

FIG. 17 illustrates the NMR spectrum of SB-alkyne.

FIG. 18 illustrates the comparison of FTIR spectra of a PSi-g-VBA surface before and after click reaction. An FTIR spectrum from a control experiment with the same reaction conditions, only omitting the DBCO-PEG4-biotin, is also included.

FIG. 19 illustrates the comparison of FTIR spectra of a PSI-g-VBA surfaces prepared with and without Freeze-Pump-Thaw degassing of the liquid VBA before UV exposure. (Note: the degassed spectrum is scaled up to match azide peak size for easier comparison)

FIG. 20 illustrates the FTIR spectra of a PSi-g-VBA reacted via click chemistry with benzaldehyde propargylether and then etched in HF for 5 minutes to remove oxidized silicon. The FTIR spectrum of benzaldehyde propargyl ether is provided for comparison.

FIG. 21 illustrates the FTIR spectra of a PSi-g-VBA before and after click reaction with benzaldehyde propargylether. The latter was then etched in HF for 5 minutes to remove oxidized silicon and analyzed again via FTIR. The FTIR spectrum of freshly HF-etched porous silicon is provided for comparison.

FIG. 22 illustrates the apparatus used for the synthesis of 1,4-bis(dimethylamino)-2-butyne.

FIG. 23 illustrates the NMR spectrum of 1,4-dichloro-2-butyne.

FIG. 24 illustrates the NMR spectrum of 1,4-bis(dimethylamino)-2-butyne.

FIG. 25 illustrates the NMR spectrum of the dual zwitterionic alkyne (DZA).

FIG. 26 illustrates the FTIR spectra for SB-alkyne, a terminal alkyne, where the peaks present at 3189 and 2123 cm⁻¹ are associated with C≡H and CEC stretching respectively. As would be expected for an alkyne which is both internal and symmetric, these are not present in DZA.

FIG. 27 illustrates a schematic of reactions involving methods of the present disclosure.

FIG. 28 illustrate an embodiment of the method and structure that includes patterning of the moiety including the azide.

### DETAILED DESCRIPTION

Before the present disclosure is described in greater detail, it is to be understood that this disclosure is not limited to particular embodiments described, as such may, of course, vary. It is also to be understood that the terminology used herein is for the purpose of describing particular embodiments only, and is not intended to be limiting, since the scope of the present disclosure will be limited only by the appended claims.

Where a range of values is provided, it is understood that each intervening value, to the tenth of the unit of the lower limit (unless the context clearly dictates otherwise), between the upper and lower limit of that range, and any other stated or intervening value in that stated range, is encompassed within the disclosure. The upper and lower limits of these smaller ranges may independently be included in the smaller ranges and are also encompassed within the disclosure, subject to any specifically excluded limit in the stated range. Where the stated range includes one or both of the limits, ranges excluding either or both of those included limits are also included in the disclosure.

Unless defined otherwise, all technical and scientific terms used herein have the same meaning as commonly understood by one of ordinary skill in the art to which this disclosure belongs. Although any methods and materials similar or equivalent to those described herein can also be used in the practice or testing of the present disclosure, the preferred methods and materials are now described.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure. Any recited method can be carried out in the order of events recited or in any other order that is logically possible.

Embodiments of the present disclosure will employ, unless otherwise indicated, techniques of chemistry, organic chemistry, synthetic chemistry, material science, and the like, which are within the skill of the art. Such techniques are explained fully in the literature.

The following description and examples are put forth so as to provide those of ordinary skill in the art with a complete disclosure and description of how to perform the methods and use the compositions and compounds disclosed and claimed herein. Efforts have been made to ensure accuracy with respect to numbers (e.g., amounts, temperature, etc.), but some errors and deviations should be accounted for. Unless indicated otherwise, parts are parts by weight, temperature is in ° C., and pressure is in bar or psig. Standard temperature and pressure are defined as 25° C. and 1 bar.

Before the embodiments of the present disclosure are described in detail, it is to be understood that, unless otherwise indicated, the present disclosure is not limited to particular materials, reagents, reaction materials, manufacturing processes, or the like, as such can vary. It is also to be understood that the terminology used herein is for purposes of describing particular embodiments only, and is not intended to be limiting. It is also possible in the present disclosure that steps can be executed in different sequence where this is logically possible. Different stereochemistry is also possible, such as products of cis or trans orientation around a carbon-carbon double bond or syn or anti addition could be both possible even if only one is drawn in an embodiment.

It must be noted that, as used in the specification and the appended claims, the singular forms “a,” “an,” and “the” include plural referents unless the context clearly dictates otherwise. Thus, for example, reference to “a support” includes a plurality of supports. In this specification and in the claims that follow, reference will be made to a number of terms that shall be defined to have the following meanings unless a contrary intention is apparent.

### Definitions

It is understood that “substitution” or “substituted” includes the implicit proviso that such substitution is in accordance with permitted valence of the substituted atom and the substituent, and that the substitution results in a stable compound, i.e., a compound that does not spontaneously undergo transformation such as by rearrangement, cyclization, elimination, etc.

It will be understood by those skilled in the art that the moieties substituted can themselves be substituted, if appropriate. For instance, the substituents of a substituted alkyl may include halogen, hydroxy, nitro, thiols, amino, azido, imino, amido, phosphoryl (including phosphonate and phosphinate), sulfonyl (including sulfate, sulfonamido, sulfamoyl and sulfonate), and silyl groups, as well as ethers, alkylthios, carbonyls (including ketones, aldehydes, carboxylates, and esters), —CF₃, —CN and the like. Cycloalkyls can be substituted in the same manner.

The term “monovalent” when referring to a function group means that the functional group can form a single bond (e.g., —CH₃, —CH₂—CH₃, —R_{UR}), while the term “bivalent” when referring to a function group means that the functional group can form two single bonds (e.g., —CH₂— (methylene), —CH₂CH₂—, —CH₂C(CH₃)₂CH₂—, —CH₂CH₂CH₂—, —R_{S}—). While monovalent or bivalent may not be used in each instance, it is implicit that inclusion of functional groups is made in accordance with the permitted valence of the atoms in question. In an example, R_{S} is a bivalent group (e.g., —R_{S}—) that is bonded to both N₃ and R_{UR} in the following structure: N₃—R_{S}—R_{UR}.

As used herein, the term “halo” or “halogen” alone or as part of another substituent means, unless otherwise stated, a fluorine, chlorine, bromine, or iodine atom. In one aspect, halo includes fluorine, chlorine, or bromine. In one aspect, halo includes fluorine or chlorine.

As used herein, “aliphatic” or “aliphatic group” refers to a saturated or unsaturated, linear or branched, cyclic (non-aromatic), hydrocarbon or hydrocarbon group. In an aspect, the aliphatic group can have 1 to 30 carbons, 1 to 20 carbons, 1 to 10 carbons, or 1 to 6 carbons. The aliphatic group can be monovalent (e.g., —CH₃) or bivalent (e.g., —CH₂—) as is appropriate for the particular situation.

As used herein, “hetero-carbon group” is similar to the aliphatic group except for the presence of one or more hetero atoms. Otherwise, the hetero-carbon group refers to a saturated or unsaturated, linear or branched, cyclic (non-aromatic), group. In an aspect, the hetero-carbon group can have 1 to 30 carbons, 1 to 20 carbons, 1 to 10 carbons, or 1 to 6 carbons, and 1 to 10, 1 to 5, 1 to 3, or 1 to 2 heteroatoms. The hetero-carbon group can be monovalent (e.g., —CH₂CH₂OH) or bivalent (e.g., —CH₂C(O)CH₂—,) as is appropriate for the particular situation.

As used herein, “heteroatom” means an atom of any element other than carbon or hydrogen. Examples of heteroatoms are boron, nitrogen, oxygen, phosphorus, sulfur and selenium. Other heteroatoms include silicon and arsenic.

As used herein, “carbocycle”, refers to an aromatic (e.g., aryl group) or non-aromatic ring in which each atom of the ring is carbon. The carbocyle can be C₃-C₁₀-membered C₅-C₁₀-membered aromatic or non-aromatic ring. The carbocycle group can be monovalent or bivalent as is appropriate for the particular situation.

As used herein, “heterocycle”, is similar to a carbocycle except the cycle includes at least one heteroatom. A heterocycle refers to an aromatic or non-aromatic ring in which at least one heteroatom is included in a carbon ring. The heterocycle can be C₂-C₁₀-membered C₄-C₁₀-membered aromatic or non-aromatic ring that also includes at least one heteroatom. Additional examples of heterocycles are provided herein. The heterocycle group can be monovalent or bivalent as is appropriate for the particular situation.

As used herein, the term “alkyl,” by itself or as part of another substituent means, unless otherwise stated, a straight or branched chain hydrocarbon having the number of carbon atoms designated (i.e., C₁-C₁₀ means one to ten carbon atoms) and includes straight, branched chain, or cyclic substituent groups. In some embodiments, a straight chain or branched chain alkyl has 30 or fewer carbon atoms in its backbone (e.g., C₁-C₃₀ for straight chains, C₃-C₃₀ for branched chains), 20 or fewer, 12 or fewer, or 7 or fewer. Likewise, in some embodiments cycloalkyls have from 3-10 carbon atoms in their ring structure, e.g. have 5, 6 or 7 carbons in the ring structure. Examples include methyl, ethyl, propyl, isopropyl, butyl, isobutyl, tert-butyl, pentyl, neopentyl, hexyl, and cyclopropylmethyl. Other examples include (C₁-C₆) alkyl, such as, but not limited to, ethyl, methyl, isopropyl, isobutyl, n-pentyl, n-hexyl and cyclopropylmethyl.

The terms “alkenyl” and “alkynyl”, refer to unsaturated aliphatic groups analogous in length and possible substitution to the alkyls described above, but that contain at least one double or triple bond respectively. Examples of “alkenyl” include vinyl, propenyl (or allyl), crotyl, isopentenyl, butadienyl, 1,3-pentadienyl, 1,4-pentadienyl, and the higher homologs and isomers. A functional group representing an alkene is exemplified by —CH₂—CH═CH₂. Non-limiting examples of “alkynyl” include ethynyl, propynyl, and larger carbon chains with a triple bond.

“Aryl”, as used herein, refers to C₅-C₁₀-membered aromatic, heterocyclic, fused aromatic, fused heterocyclic, biaromatic, or biheterocyclic ring systems. Broadly defined, “aryl”, as used herein, includes 5-, 6-, 7-, 8-, 9-, and 10-membered single-ring aromatic groups that may include from zero to four heteroatoms, for example, benzene, pyrrole, furan, thiophene, imidazole, oxazole, thiazole, triazole, pyrazole, pyridine, pyrazine, pyridazine and pyrimidine, and the like. Those aryl groups having heteroatoms in the ring structure may also be referred to as “aryl heterocycles” or “heteroaromatics”. The aromatic ring can be substituted at one or more ring positions with one or more substituents including, but not limited to, halogen, azide, alkyl, aralkyl, alkenyl, alkynyl, cycloalkyl, hydroxyl, alkoxyl, amino (or quaternized amino), nitro, sulfhydryl, imino, amido, phosphonate, phosphinate, carbonyl, carboxyl, silyl, ether, alkylthio, sulfonyl, sulfonamido, ketone, aldehyde, ester, heterocyclyl, aromatic or heteroaromatic moieties, —CF₃, —CN; and combinations thereof.

The term “aryl” also includes polycyclic ring systems having two or more cyclic rings in which two or more carbons are common to two adjoining rings (i.e., “fused rings”) wherein at least one of the rings is aromatic, e.g., the other cyclic ring or rings can be cycloalkyls, cycloalkenyls, cycloalkynyls, aryls and/or heterocycles. Examples of heterocyclic rings include, but are not limited to, benzimidazolyl, benzofuranyl, benzothiofuranyl, benzothiophenyl, benzoxazolyl, benzoxazolinyl, benzthiazolyl, benztriazolyl, benztetrazolyl, benzisoxazolyl, benzisothiazolyl, benzimidazolinyl, carbazolyl, 4aH carbazolyl, carbolinyl, chromanyl, chromenyl, cinnolinyl, decahydroquinolinyl, 2H,6H-1,5,2-dithiazinyl, dihydrofuro[2,3b]tetrahydrofuran, furanyl, furazanyl, imidazolidinyl, imidazolinyl, imidazolyl, 1H-indazolyl, indolenyl, indolinyl, indolizinyl, indolyl, 3H-indolyl, isatinoyl, isobenzofuranyl, isochromanyl, isoindazolyl, isoindolinyl, isoindolyl, isoquinolinyl, isothiazolyl, isoxazolyl, methylenedioxyphenyl, morpholinyl, naphthyridinyl, octahydroisoquinolinyl, oxadiazolyl, 1,2,3-oxadiazolyl, 1,2,4-oxadiazolyl, 1,2,5-oxadiazolyl, 1,3,4-oxadiazolyl, oxazolidinyl, oxazolyl, oxindolyl, pyrimidinyl, phenanthridinyl, phenanthrolinyl, phenazinyl, phenothiazinyl, phenoxathinyl, phenoxazinyl, phthalazinyl, piperazinyl, piperidinyl, piperidonyl, 4-piperidonyl, piperonyl, pteridinyl, purinyl, pyranyl, pyrazinyl, pyrazolidinyl, pyrazolinyl, pyrazolyl, pyridazinyl, pyridooxazole, pyridoimidazole, pyridothiazole, pyridinyl, pyridyl, pyrimidinyl, pyrrolidinyl, pyrrolinyl, 2H-pyrrolyl, pyrrolyl, quinazolinyl, quinolinyl, 4H-quinolizinyl, quinoxalinyl, quinuclidinyl, tetrahydrofuranyl, tetrahydroisoquinolinyl, tetrahydroquinolinyl, tetrazolyl, 6H-1,2,5-thiadiazinyl, 1,2,3-thiadiazolyl, 1,2,4-thiadiazolyl, 1,2,5-thiadiazolyl, 1,3,4-thiadiazolyl, thianthrenyl, thiazolyl, thienyl, thienothiazolyl, thienooxazolyl, thienoimidazolyl, thiophenyl and xanthenyl. One or more of the rings can be substituted as defined above for “aryl”.

As used herein, the terms “heteroalkyl”, “alkenyl”, and the like by itself or in combination with another term means, unless otherwise stated, a stable straight or branched chain group consisting of the stated number of carbon atoms and one or two heteroatoms selected from the group consisting of B, O, N, S, and P and wherein the nitrogen, sulfur, and phosphorous atoms may be optionally oxidized and the nitrogen heteroatom may be optionally quaternized. The heteroatom(s) may be placed at any position, including between the rest of the heteroalkyl group and the fragment to which it is attached, as well as attached to the most distal carbon atom in the heteroalkyl group. Examples include: —O—CH₂—CH₂—CH₃, —CH₂—CH₂—CH₂—OH, —CH₂—CH₂—NH—CH₃, —CH₂—S—CH₂—CH₃, and —CH₂CH₂—S(═O)—CH₃. Up to two heteroatoms may be consecutive, such as, for example, —CH2—NH—OCH₃, or —CH₂—CH₂—S—S—CH₃.

“Heterocycle” or “heterocyclic”, as used herein, refers to a cyclic radical attached via a ring carbon or nitrogen of a monocyclic or bicyclic ring containing 3-10 ring atoms, and preferably from 5-6 ring atoms, consisting of carbon and one to four heteroatoms each selected from the group consisting of non-peroxide oxygen, sulfur, and N(Y) wherein Y is absent or is H, O, (C₁-C₁₀) alkyl, phenyl or benzyl, and optionally containing 1-3 double bonds and optionally substituted with one or more substituents. Examples of heterocyclic ring include, but are not limited to, benzimidazolyl, benzofuranyl, benzothiofuranyl, benzothiophenyl, benzoxazolyl, benzoxazolinyl, benzthiazolyl, benztriazolyl, benztetrazolyl, benzisoxazolyl, benzisothiazolyl, benzimidazolinyl, carbazolyl, 4aH carbazolyl, carbolinyl, chromanyl, chromenyl, cinnolinyl, decahydroquinolinyl, 2H,6H-1,5,2-dithiazinyl, dihydrofuro[2,3b]tetrahydrofuran, furanyl, furazanyl, imidazolidinyl, imidazolinyl, imidazolyl, 1H-indazolyl, indolenyl, indolinyl, indolizinyl, indolyl, 3H-indolyl, isatinoyl, isobenzofuranyl, isochromanyl, isoindazolyl, isoindolinyl, isoindolyl, isoquinolinyl, isothiazolyl, isoxazolyl, methylenedioxyphenyl, morpholinyl, naphthyridinyl, octahydroisoquinolinyl, oxadiazolyl, 1,2,3-oxadiazolyl, 1,2,4-oxadiazolyl, 1,2,5-oxadiazolyl, 1,3,4-oxadiazolyl, oxazolidinyl, oxazolyl, oxepanyl, oxetanyl, oxindolyl, pyrimidinyl, phenanthridinyl, phenanthrolinyl, phenazinyl, phenothiazinyl, phenoxathinyl, phenoxazinyl, phthalazinyl, piperazinyl, piperidinyl, piperidonyl, 4-piperidonyl, piperonyl, pteridinyl, purinyl, pyranyl, pyrazinyl, pyrazolidinyl, pyrazolinyl, pyrazolyl, pyridazinyl, pyridooxazole, pyridoimidazole, pyridothiazole, pyridinyl, pyridyl, pyrimidinyl, pyrrolidinyl, pyrrolinyl, 2H-pyrrolyl, pyrrolyl, quinazolinyl, quinolinyl, 4H-quinolizinyl, quinoxalinyl, quinuclidinyl, tetrahydrofuranyl, tetrahydroisoquinolinyl, tetrahydropyranyl, tetrahydroquinolinyl, tetrazolyl, 6H-1,2,5-thiadiazinyl, 1,2,3-thiadiazolyl, 1,2,4-thiadiazolyl, 1,2,5-thiadiazolyl, 1,3,4-thiadiazolyl, thianthrenyl, thiazolyl, thienyl, thienothiazolyl, thienooxazolyl, thienoimidazolyl, thiophenyl and xanthenyl. Heterocyclic groups can optionally be substituted with one or more substituents at one or more positions as defined above for alkyl and aryl, for example, halogen, alkyl, aralkyl, alkenyl, alkynyl, cycloalkyl, hydroxyl, amino, nitro, sulfhydryl, imino, amido, phosphate, phosphonate, phosphinate, carbonyl, carboxyl, silyl, ether, alkylthio, sulfonyl, ketone, aldehyde, ester, a heterocyclyl, an aromatic or heteroaromatic moiety, —CF₃, and —CN.

The term “carbonyl” is art-recognized and includes such moieties as can be represented by the general formula:

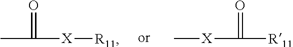

where X is a bond or represents an oxygen or a sulfur, and R₁₁ represents a hydrogen, an alkyl, a cycloalkyl, an alkenyl, a cycloalkenyl, or an alkynyl, R′₁₁ represents a hydrogen, an alkyl, a cycloalkyl, an alkenyl, a cycloalkenyl, or an alkynyl. Where X is an oxygen and R₁₁ or R′₁₁ is not hydrogen, the formula represents an “ester”. Where X is an oxygen and R₁₁ is as defined above, the moiety is referred to herein as a carboxyl group, and particularly when R₁₁ is a hydrogen, the formula represents a “carboxylic acid”. Where X is an oxygen and R′₁₁ is hydrogen, the formula represents a “formate”. In general, where the oxygen atom of the above formula is replaced by sulfur, the formula represents a “thiocarbonyl” group. Where X is a sulfur and R₁₁ or R′₁₁ is not hydrogen, the formula represents a “thioester.” Where X is a sulfur and R₁₁ is hydrogen, the formula represents a “thiocarboxylic acid.” Where X is a sulfur and R′₁₁ is hydrogen, the formula represents a “thioformate.” On the other hand, where X is a bond, and R₁₁ is not hydrogen, the above formula represents a “ketone” group. Where X is a bond, and R₁₁ is hydrogen, the above formula represents an “aldehyde” group.

The term “nitrile” refers to R′—C≡N, where R′ is selected from an alkyl, an alkenyl, a carbocycle group, a heterocyclo, an aryl, or a heteroaryl.

The term “imine” refers to R′₁—N═CR″R″, where R′, R″, and R″ are each independently selected from an alkyl, an alkenyl, a carbocycle group, a heterocyclo, an aryl, or a heteroaryl.

The term “substituted” as used herein, refers to all permissible substituents of the compounds described herein. In the broadest sense, the permissible substituents include acyclic and cyclic, branched and unbranched, carbocyclic and heterocyclic, aromatic and nonaromatic substituents of organic compounds. Illustrative substituents include, but are not limited to, halogens, hydroxyl groups, or any other organic groupings containing any number of carbon atoms, preferably 1-14 carbon atoms, and optionally include one or more heteroatoms such as oxygen, sulfur, or nitrogen grouping in linear, branched, or cyclic structural formats. Representative substituents include alkyl, substituted alkyl, alkenyl, substituted alkenyl, alkynyl, substituted alkynyl, phenyl, substituted phenyl, aryl, substituted aryl, heteroaryl, substituted heteroaryl, halo, hydroxyl, alkoxy, substituted alkoxy, phenoxy, substituted phenoxy, aroxy, substituted aroxy, alkylthio, substituted alkylthio, phenylthio, substituted phenylthio, arylthio, substituted arylthio, cyano, isocyano, substituted isocyano, carbonyl, substituted carbonyl, carboxyl, substituted carboxyl, amino, substituted amino, amido, substituted amido, sulfonyl, substituted sulfonyl, sulfonic acid, phosphoryl, substituted phosphoryl, phosphonyl, substituted phosphonyl, polyaryl, substituted polyaryl, C3-C20 cyclic, substituted C₃-C₂₀ cyclic, heterocyclic, substituted heterocyclic, aminoacid, peptide, and polypeptide groups.

Heteroatoms such as nitrogen may have hydrogen substituents and/or any permissible substituents of organic compounds described herein which satisfy the valences of the heteroatoms.

In various embodiments, the substituent is selected from alkoxy, aryloxy, alkyl, alkenyl, alkynyl, amide, amino, aryl, arylalkyl, carbamate, carboxy, cyano, cycloalkyl, ester, ether, formyl, halogen, haloalkyl, heteroaryl, heterocyclyl, hydroxyl, ketone, nitro, phosphate, sulfide, sulfinyl, sulfonyl, sulfonic acid, sulfonamide, and thioketone, each of which optionally is substituted with one or more suitable substituents. In some embodiments, the substituent is selected from alkoxy, aryloxy, alkyl, alkenyl, alkynyl, amide, amino, aryl, arylalkyl, carbamate, carboxy, cycloalkyl, ester, ether, formyl, haloalkyl, heteroaryl, heterocyclyl, ketone, phosphate, sulfide, sulfinyl, sulfonyl, sulfonic acid, sulfonamide, and thioketone, wherein each of the alkoxy, aryloxy, alkyl, alkenyl, alkynyl, amide, amino, aryl, arylalkyl, carbamate, carboxy, cycloalkyl, ester, ether, formyl, haloalkyl, heteroaryl, heterocyclyl, ketone, phosphate, sulfide, sulfinyl, sulfonyl, sulfonic acid, sulfonamide, and thioketone can be further substituted with one or more suitable substituents.

Examples of substituents include, but are not limited to, halogen, azide, alkyl, aralkyl, alkenyl, alkynyl, cycloalkyl, hydroxyl, alkoxyl, amino, nitro, sulfhydryl, imino, amido, phosphonate, phosphinate, carbonyl, carboxyl, silyl, ether, alkylthio, sulfonyl, sulfonamido, ketone, aldehyde, thioketone, ester, heterocyclyl, —CN, aryl, aryloxy, perhaloalkoxy, aralkoxy, heteroaryl, heteroaryloxy, heteroarylalkyl, heteroaralkoxy, azido, alkylthio, oxo, acylalkyl, carboxy esters, carboxamido, acyloxy, aminoalkyl, alkylaminoaryl, alkylaryl, alkylaminoalkyl, alkoxyaryl, arylamino, aralkylamino, alkylsulfonyl, carboxamidoalkylaryl, carboxamidoaryl, hydroxyalkyl, haloalkyl, alkylaminoalkylcarboxy, aminocarboxamidoalkyl, cyano, alkoxyalkyl, perhaloalkyl, arylalkyloxyalkyl, and the like. In some embodiments, the substituent is selected from cyano, halogen, hydroxyl, and nitro.

### General Discussion

Embodiments of the present disclosure provide for methods to attach an organic azide to H-terminated groups (e.g., H-terminated silicon surfaces or molecules), products of the methods, structures including a moiety including an azide, sensors including the products and structure, methods of sensing, and the like. In an aspect, the method of attaching an organic azide to an H-terminated group can be achieved using a one-step (e.g., one-step hydrosilylation) approach, while in other aspects the method may include more than one step). In an aspect, the present disclosure provides for a process of attaching an organic azide molecule to a surface (e.g., a non-porous or porous silicon substrate including Si—H) by a silicon-carbon bond linkage by hydrosilylation, where the silicon-carbon bond is between structural silicon of the surface and not via an intermediary silicon linker (e.g., silanol group) separately attached to the structural silicon of the surface (e.g., not forming a siloxane linkage). Other aspects of the method provide for processes of attaching an organic azide molecule to a surface (e.g., a non-porous or porous silicon substrate including Si—H) by a silicon-oxygen or silicon-nitrogen bond linkage by hydrosilylation, where the bond is between structural silicon of the surface and not via an intermediary silicon linker (e.g., silanol group) separately attached to the structural silicon of the surface (e.g., not forming a siloxane linkage) The ability to attach an organic azide to a surface by the methods presented herein, for example, is unexpected due to azides being known to degrade in many cases where UV or heat is applied. The methods of the present disclosure are advantageous in that attachment of the azide to the surface was performed and is efficient and cost effective.

In a particular embodiment, an organic azide (e.g., 4-vinylbenzyl azide (VBA)) was attached to H-terminated silicon surfaces by a one-step UV-induced hydrosilylation method. In addition to flat silicon substrates, attachment of VBA to porous silicon (PSi) substates was performed and verified via FT-IR analysis. Furthermore, the presence of the attached azide to PSi surfaces and its usefulness for click chemistry by “clicking” an assortment of alkynes to azide surface via both copper(I)-catalyzed azide alkyne cycloaddition (CuAAC) and also copper-free click chemistry using a ring-strained alkyne has been demonstrated, verifying successful attachment via FTIR in each case. Additionally, biotinylation of the substrates was performed via copper-free click reaction between an alkyne-containing biotin compound and the g-VBA (i.e., “g-VBA” indicates that a surface/substrate has been reacted with VBA in such a way that a covalent bond has formed between VBA and the surface/substrate) surface to demonstrate the utility of the azide-modified porous silicon samples for biosensing applications afforded by the porous substrate.

The present disclosure provides for methods of attaching an organic azide to a H-terminated group. In aspects, the method can be a one-step method and in other aspects the method can be two or more steps. In general, the method includes contacting a solution including the organic azide with the H-terminated group. The solution can include only the organic azide or can be the organic azide and a solvent (e.g., xylene). In an aspect, the organic azide can be used in a pure form, an undiluted form, or mixed with a solvent. The organic azide and the H-terminated group are exposed to an energy source, a catalyst, or a combination of the energy source and the catalyst for a period of time. The period of time can be enough to cause the reactive group of the organic azide compound and the H-terminated group to react with consideration given to reactant stability, reactant concentration, type and intensity of the energy source or the type of catalyst, and the like. In general, the time period is about 10 s of seconds (e.g., about 1 to 60 seconds), 1 to 10 minutes, or longer depending upon the choice of SiH-containing and azide-containing materials used (e.g., porous surfaces require longer time periods than non-porous surfaces in general), particular design (e.g., dimensions, and the like) of the structure to be formed, and equipment used (e.g., energy source type, energy source intensity, catalyst, catalyst concentration, and the like). The exposure results in the formation of a covalent bond between the reactive group of the organic azide and the H-terminated group to form a moiety including an azide. The atomic composition of the covalent bond to the silicon depends on the reactive group. The bond formed between the surface and the moiety including the azide can be a silicon-carbon bond when the reactive group is an alkene or alkyne, for example, a silicon-nitrogen bond when the reactive group is a nitrile or imine, for example, or a silicon-oxygen bond when the reactive group contains a carbonyl, for example. The bond forms without the use of an additional linking group, such as a silanol for silicon surfaces. The method includes forming a monolayer or fraction of a monolayer of azide moiety on the surface. The present disclosure includes the structures formed using the methods of the present disclosure.

In an aspect, the H-terminated group can be a H-terminated surface of a structure or a H-terminated group of a molecule. The molecule can be a smaller molecule or can be a more complex molecule such as a polymer. The molecule can be insoluble or can be soluble in a solvent. In one aspect the molecule can be an insoluble polymer in a solvent while in another aspect, the molecule can be a soluble polymer is a solvent. When the molecule is a polymer, the polymer can include Si—H groups. In an aspect, the polymer including the Si—H groups has a structure, where the Si—H groups can exist at the initiating or terminating ends of the polymer chain(s), where the Si—H groups exist within the backbone of the polymer chain(s), where the Si—H groups exist on/within branches or pendent groups along the polymer chain, where the Si—H groups exist on cross-links within the polymer, or a polymer including any combination thereof. A representative polymer including Si—H groups along the backbone of the polymer can include Dow's XIAMETER™ MHX-1107, polymethylhydrogensiloxane polymer with reactive hydrogen functionality. A representative polymer including the Si—H group at the end of the polymer chain can include hydrogen-terminated silicone fluids available from Genesee Polymers Corporation such as a hydride end-blocked silicon fluid. The term “Si—H group” when used in reference to a molecule or polymer can refer to RR′R″SiH, RR′SiH₂, RSiH₃, or SiH₄, where each of R, R′, and R″ can be the same or different. In an aspect, each of R, R′, and R″ can be independently selected to be a substituted or unsubstituted, linear or branched aliphatic group, a substituted or unsubstituted, linear or branched hetero-carbon group including moieties attached to Si by oxygen, nitrogen, sulfur or other heteroatoms (e.g., CH₃O— and CH₃CH₂O—), a substituted or unsubstituted, carbocyle group, or substituted or unsubstituted, heterocyclo group, all of which could be part of a molecule, or part of a portion of either a soluble or insoluble polymer or polymer support. In an aspect, each of R, R′, and R″ can be independently selected from an alkyl group. In an aspect, each of R, R′, and R″ can be independently selected to be molecular or polymeric species.

In an embodiment, the H-terminated group is a H-terminated surface. For example, the H-terminated surface can be of a structure such as a silicon structure (e.g., silicon wafer) or a group IV element (e.g., germanium, graphene, or diamond). The structure can have dimensions from the nanoscale to microscale to millimeter scale to the centimeter scale. The H-terminated group can be composed of the material of the structure or a combination of H-terminated groups. In an aspect, the H-terminated groups can be C—H, Ge—H, Sn—H, Pb—H, or Si—H, where a surface of the structure can include one of these H-terminated groups or a combination of two or more of the H-terminated groups. In an embodiment, when the H-terminated group is a H-terminated silicon surface and the reactive group of the organic azide is an alkene, a silicon-carbon bond is formed between the surface and the moiety including the azide. In other words, the surface includes structural surface Si atoms (Si atoms native to the structure), so that the linkage is to Si—H as opposed to a silanol group, for example. Use of a silanol group is a common way of surface modification between surface Si—OH groups and electrophilic reagents but in embodiments of the present disclosure the formed covalent bond is directly to the silicon of the structure. Similarly, a bond is formed with the structural surface atoms (e.g., that corresponded to the C—H, Ge—H, Sn—H, Pb—H, or Si—H prior to reaction) as opposed through a linker group.

In an aspect, the H-terminated surface is a H-terminated silicon surface of a silicon structure, silicon nitride structure, or silicon carbide structure. The silicon structure can be a non-porous silicon structure or a porous silicon structure. The silicon structure can be a silicon particle (e.g., about 5 nm to wafer size silicon particles, about 5 nm to 1 cm, or about 500 nm to 1 micrometer) in diameter or the longest dimension), a silicon nanowire (e.g., having an aspect ratio of about 10² to 10⁴ or greater), a nanorod, a nanobeam, a nanopillar, a nanoribbon, or the like. In another aspect, the silicon structure can be a silicon wafer or sheet, fractional part of the silicon wafer, a silicon ingot, fractional part of the silicon ingot, or fabricated silicon-containing structure on these or other platforms.

FIG. 27 illustrates embodiments of methods of the present disclosure where the silicon structure is a silicon wafer having Si—H groups. In one aspect, the organic azide is 4-vinylbenzyl azide, while in another a precursor material 4-vinylbenzyl chloride is bonded to the surface and then the chloride group is reacted with NaN₃ to form the azide group of the moiety including the azide. Subsequently, the structure including the moiety including the azide is reacted with an alkyne using a click reaction to produce a useful product.

In an aspect, the organic azide includes at least one azide group (—N₃) and at least one unsaturated reactive group (R_{UR}) (e.g., reactive with the H-terminated group such as Si—H). In particular the organic azide can be a molecule that includes one azide group and one reactive group, while in other aspects the organic azide can be a more complex molecule that includes 2 or more azide groups and/or 2 or more reactive groups, or a polymer or more complex molecule that includes 10 s, 100 s, or more of azide groups and/or 10 s, 100 s, or more of reactive groups. The unsaturated reactive group, R_{UR}, is configured to react to form the covalent bond between the organic azide and the H-terminated group. R_{UR} can be an alkenyl group, an alkynyl group, a carbonyl group, a ketone group, an aldehyde group, a nitrile group, or an imine group and where multiple R_{UR} group are present, two or more types can be present or all of the R_{UR} groups can be the same.

In an embodiment, the organic azide has one of the following structures:

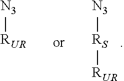

R_{S} can be a bivalent group that bonds to both R_{UR} and the azide (N₃). The R_{S} group can be a bivalent, substituted or unsubstituted, linear or branched, aliphatic group; a bivalent, substituted or unsubstituted, linear or branched, hetero-carbon group; a bivalent, substituted or unsubstituted, carbocyle group; or a bivalent, substituted or unsubstituted, heterocyclo group. R_{UR} can be an alkenyl group, an alkynyl group, a carbonyl group, a ketone group, an aldehyde group, a nitrile group, or an imine group.

In another embodiment, the organic azide has one of the following structure:

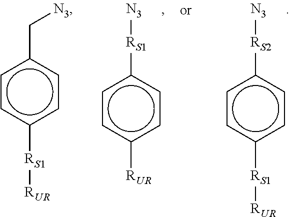

R_{UR} can be an alkenyl group, an alkynyl group, a carbonyl group, a ketone group, an aldehyde group, a nitrile group, or an imine group. R_{S}, R_{S1}, and R_{S2} are each independently selected from a bivalent, substituted or unsubstituted, linear or branched, aliphatic group; a bivalent, substituted or unsubstituted, linear or branched, hetero-carbon group; a bivalent, substituted or unsubstituted, carbocyle group; or a bivalent, substituted or unsubstituted, heterocyclo group.

In a particular aspect, the organic azide has the following structure:

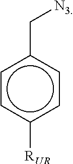

R_{UR} can be an alkenyl group, an alkynyl group, a carbonyl group, a ketone group, an aldehyde group, a nitrile group, or an imine group. In particular, R_{UR} is an alkenyl group, specifically a vinyl group.

In another aspect, the azide is formed after a group forms a bond to the H-terminated group. In this regard, the moiety including the azide can ultimately be formed from one of the following structures:

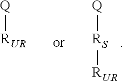

R_{S} can be a bivalent, substituted or unsubstituted, linear or branched, aliphatic group; a bivalent, substituted or unsubstituted, linear or branched, hetero-carbon group; a bivalent, substituted or unsubstituted, carbocyle group; or a bivalent, substituted or unsubstituted, heterocyclo group. R_{UR} can be an alkenyl group, an alkynyl group, a carbonyl group, a ketone group, an aldehyde group, a nitrile group, or an imine group. Q can be a halide or leaving group that is characterized in that it can be converted to an azide group. In an aspect the Q can be replaced with an azide group by nucleophilic substitution. In an aspect, Q can be reacted to form the moiety including the azide. Q can be an alkyl halide, a benzyl halide, an aryl halide, or a sulfonate ester. Q can be reacted with NaN₃, an azide anion, or salts of the azide anion to form the azide of the moiety including the azide. In an example, Q is a halogen (e.g., chloride) and is reacted with NaN₃ to form the moiety including the azide. In another aspect, Q can include one or more azide groups and one or more groups (e.g., an alkyl halide, a benzyl halide, an aryl halide, or a sulfonate ester) that can be reacted by nucleophilic substitution to form the azide group.

In an aspect, an energy source can be used to facilitate the reaction of the organic azide and the H-terminated group. The energy source can include light energy, heating (thermal energy), sonication energy, microwave energy, or a combination thereof. In an aspect, the light energy can be from light sources (e.g., bulb, LED, lamp) such as incandescent light source, fluorescent light source, laser, neon light source, tungsten-halogen light source, mercury-vapor light source, and sodium-vapor light source. The light energy can be UV light (e.g., produce by a curing lamp or LED systems, for example the DYMAX 5000-EC UV curing lamp system can be used) or white light (e.g., produced by an LED or lamp). The thermal energy can heat the mixture and H-terminated group to a temperature of about 30 to 250° C. to about 60 to 120° C. or about 75° C. The sonication energy can be used to react the unsaturated reactive group (R_{UR}) of the organic azide and the H-terminated group. For example, the organic azide and the H-terminated group can be exposed to ultrasonic energy from a sonication energy source such as those that can be purchased from Fisher Scientific or Thomas Scientific. The microwave energy can be used to react the unsaturated reactive group (R_{UR}) of the organic azide and the H-terminated group. For example, the organic azide and the H-terminated group can be exposed to microwave energy from a microwave energy source such as those that can be purchased from CEM, Fisher Scientific, or Thermo Scientific.

In an embodiment, a catalyst can be used to facilitate the reaction of the unsaturated reactive group (R_{UR}) of the organic azide and the H-terminated group. The catalyst can be a platinum catalyst, nickel catalyst, rhodium catalyst, a peroxide-based catalyst, a borane catalyst, or a combination thereof. The platinum catalyst can be a Speier's catalyst, a Karstedt's catalyst, and a Wilkinson's catalyst.

The methods of the present disclosure produce structures having a surface. The surface can include structural surface Si atoms, C atoms, Ge atoms, Sn atoms, and/or Pb atoms. A portion of the Si atoms, C atoms, Ge atoms, Sn atoms, and/or Pb atoms are covalently bonded to a carbon, a nitrogen, or an oxygen of a moiety including an azide in areas of the structure. As provided herein, the covalent bond was formed with those atoms via reaction of the C—H, Ge—H, Sn—H, Pb—H, or Si—H with the reactive group of the organic azide. The products formed can include a monolayer or fraction of a monolayer of the attached azide, where the attached azide can be formed across a large area of the structure or in discrete areas of the structure.

In an aspect, the moiety including the azide can include an embodiment where the azide is bonded to an R_{S} group. The R_{S} group can be a bivalent, substituted or unsubstituted, linear or branched, hydrocarbon group, a bivalent, substituted or unsubstituted, linear or branched, hetero-hydrocarbon group, a bivalent, substituted or unsubstituted, cycloalkyl group, or a bivalent, substituted or unsubstituted, cycloheteroalkyl group.

In an aspect, the covalent bond between the structural surface atom (e.g., Si) and an atom (e.g., C, N, O) of a moiety including an azide can be the reaction product of R_{UR} with a structural surface atom-H group (e.g., Si—H group) of the structure. The R_{UR} can be an alkenyl group, an alkynyl group, a carbonyl group, a ketone group, an aldehyde group, a nitrile group, or an imine group. In an aspect, the R_{S} group can be disposed between the R_{UR} group and the azide group.

In an aspect, at least one structural surface atom (e.g., Si) can be covalently bonded to an atom (e.g., C, N, O) of a moiety including the azide formed by the reaction of a structural surface atom-H group (e.g., Si—H group) of the structure with one organic azide having one of the following structures:

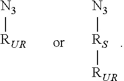

R_{S} is a bivalent, substituted or unsubstituted, linear or branched, aliphatic group; a bivalent, substituted or unsubstituted, linear or branched, hetero-carbon group; a bivalent, substituted or unsubstituted, carbocyle group; or a bivalent, substituted or unsubstituted, heterocyclo group. R_{UR} is an alkenyl group, an alkynyl group, a carbonyl group, a ketone group, an aldehyde group, a nitrile group, or an imine group.

In another aspect, at least one structural surface atom (e.g., Si) can be covalently bonded to an atom (e.g., C, N, O) of a moiety including the azide formed by the reaction of a structural surface atom-H group (e.g., Si—H group) of the structure with one organic azide having one of the following structures:

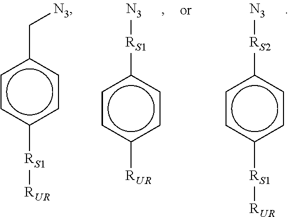

R_{UR} can be an alkenyl group, an alkynyl group, a carbonyl group, a ketone group, an aldehyde group, a nitrile group, or an imine group. R_{S}, R_{S1}, and R_{S2} are each independently selected from a bivalent, substituted or unsubstituted, linear or branched, aliphatic group; a bivalent, substituted or unsubstituted, linear or branched, hetero-carbon group; a bivalent, substituted or unsubstituted, carbocyle group; or a bivalent, substituted or unsubstituted, heterocyclo group.

In a particular embodiment, the organic azide has the following structure:

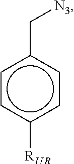

where R_{UR} is an alkenyl group, an alkynyl group, a carbonyl group, a ketone group, an aldehyde group, a nitrile group, or an imine group.

Now having described the methods and structures, additional description is provided to some specific embodiments of the method and structures formed. The specific embodiment included the following structure:

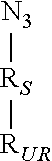

as the organic azide, where R_{UR} is varied.

If R_{UR} is a ketone group or an aldehyde group (when R₁ is H), the covalent linkage is a Si—O bond:

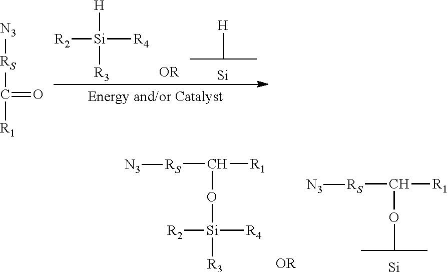

If R_{UR} is an ester group, the covalent linkage is a Si—O bond:

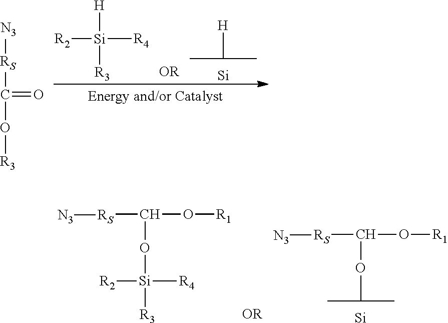

If R_{UR} is a nitrile group, the covalent linkage is a Si—N bond:

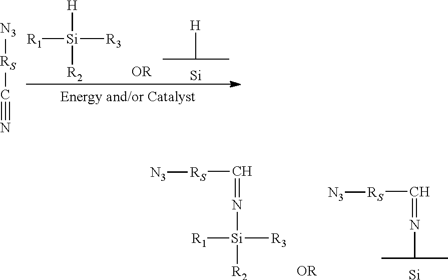

If R_{UR} is a vinyl group, the covalent linkage is a Si—C bond:

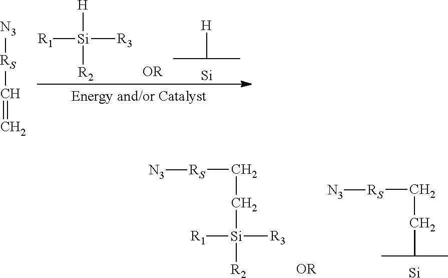

If R_{UR} a terminal alkyne, the covalent linkage is a Si—C bond:

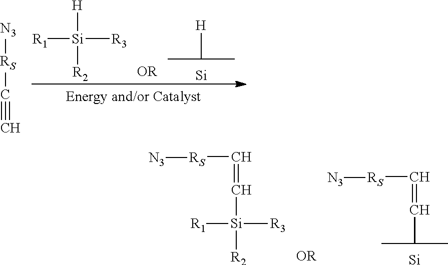

If R_{UR} is an imine, the covalent linkage is a Si—N bond:

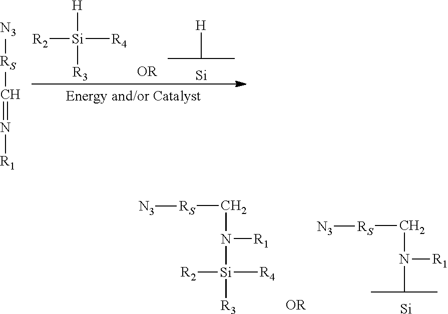

R₁, R₂, R₃, and R₄ can each be independently selected from a substituted or unsubstituted, linear or branched, aliphatic group; a substituted or unsubstituted, linear or branched; hetero-carbon group; a substituted or unsubstituted, carbocyle group; or a substituted or unsubstituted, heterocyclo group. In an aspect, R₁, R₂, R₃, and R₄ can each be independently selected from H, a halide, an alkyl, or an alkoxy. In an aspect, one or more of R₁, R₂, R₃, and R₄ can be part of a polymer such as those described herein that include Si—H. In an aspect, as shown in the right-most portion of each scheme above, the three Rₓ groups (e.g., R₁, R₂, R₃, or R₂, R₃, R₄) bonded to the Si atom may be replaced with other Si atoms as part of the structure of the substrate, as would be the case for a Si substrate such as a Si wafer.

In general, the present disclosure provides for sensors that include the structures of the present disclosure, in particular those made using methods of the present disclosure. In an aspect, the sensor includes a structure of the present disclosure where an alkyne-containing molecule (or more than one alkyne-containing molecule) is reacted with the azide-containing structure/molecule using click chemistry, where the compound that included the alkyne is now covalently attached to the structure via a triazole group formed between the azide and alkyne groups as is the case in CuAAC click chemistry. The alkyne-containing molecule includes a functional group or collection of functional groups capable of capturing, binding, absorbing, or detecting a targeted entity. In an embodiment, the alkyne-containing molecule includes a targeting agent, where the targeting agent has an affinity for a target entity (e.g. a target cell, tissue, tumor, small molecule, or biological component associated with any of these). “Affinity” as used herein refers to the targeting agent having a stronger attraction towards the target entity relative to other components of the environment. In an embodiment, the targeting agent can include, but is not limited to, a chemical agent, a biological agent (e.g., polypeptides (e.g., proteins such as, but not limited to, antibodies (monoclonal or polyclonal), fragments of antibodies), antigens, nucleic acids (both monomeric and oligomeric), peptoids, polysaccharides, haptens, sugars, fatty acids, steroids, purines, pyrimidines, ligands, and aptamers) and combinations thereof, that have an affinity for the target entity.

In an aspect, the moiety including the azide can be attached to porous silicon substrates which is a useful platform for sensing applications. Porous silicon has been demonstrated to be a highly effective platform for sensing applications as the presence of captured target molecules can be quantified via analysis of changes in position of interference fringes obtained through reflectance experiments. The biotin-streptavidin interaction system represents one of the most common coupling strategies for binding bioreceptor systems to such surfaces for capturing analytes in biosensing applications and this has been used with the present method to form azide-modified porous silicon samples (e.g., moiety including the azide attached to the porous silicon) for biosensing applications. Biotinylation of the substrates using a copper-free click reaction between an alkyne-containing biotin compound and the g-VBA (e.g., the moiety including the azide) surface has been demonstrated. Biotinylated surfaces are one common strategy to arrive at a sensing device that includes aspects of the present disclosure. Follow on uses of this platform can involve introducing a streptavidin-containing molecule (which will bond with biotin) possessing a bio-capture agent in order to utilize these g-VBA modified PSi substrates for the sensing of biomolecules. In another aspect, an alkyne-containing capture molecule could be reacted with the g-VBA (e.g., the moiety including the azide) to produce a surface with some of the properties needed to function as a sensor.

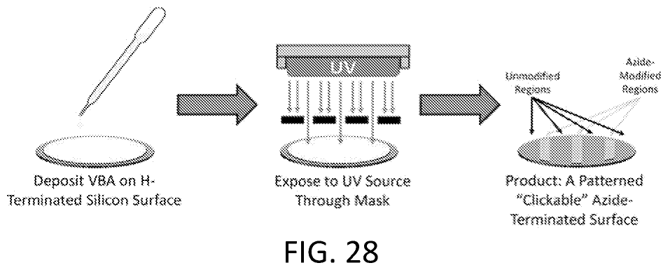

In an aspect, the process by which the organic azide is attached to a H-terminated substrate (e.g., the organic azide reacted with H-terminated silicon to covalently bond the moiety including the azide directly to the structural surface Si using a UV-light process) can be used to perform patterning of a surface with azide groups. For example, the UV-induced hydrosilylation reaction can be controlled by exposing only certain areas where the organic azide and H-terminated surface are in contact with one another to the UV light source. Attachment of the organic azide to the H-terminated surface can only occur in areas where UV light is present, and in those areas where the UV light is omitted, reaction (i.e., attachment) does not occur. The patterning can be achieved by a masking step as shown in FIG. 28.

This would enable the simple and straight-forward manufacture of arrays of sites (e.g., with moiety including the azide in those sites) that can be used for “clicking on” of specific molecules for purposes such as capture; the substrate could subsequently be modified in the un-exposed/un-reacted areas with a second molecule, possibly a silane, possessing another desired moiety, such as for fouling resistance. In this way, unique structures can be made to take advantage of the simple and efficient methods of the present disclosure.

In an aspect, the organic azide can be reacted with polymers including Si—H groups (e.g., siloxane polymers are available which contain Si—H groups either along the backbone (such as Dow's XIAMETER™ MHX-1107) or at the ends of the polymer chains (such as the “hydrogen-terminated silicone fluids” available from Genesee Polymers Corporation)) to form modified polymers with the moiety that includes the azide. These polymers can be modified using UV-attachment, for example, with the organic azides for a variety of purposes including attachment to alkyne-modified substrates or particles via “click” reactions. Further, cross-linking of modified polymers with those decorated with alkyne groups can be performed, along with end-to-end linking of the modified polymer chains with alkyne-terminated polymer chains.

Now having described the methods, additional details are provided regarding a specific embodiment of the method to form a specific structure. A VBA liquid can be deposited onto H-terminated silicon wafers, covered with a coverslip, and then exposed to a UV source. This resulted in a covalently-grafted VBA (g-VBA) surface coating. In regard to irradiation, samples including 5 μL of VBA sandwiched between the silicon surface and a No. 1 thickness coverslip were irradiated with UV light in a DYMAX 5000-EC UV curing lamp system. Total exposure times were typically about 200 s. After removal of the coverslips, the samples were immersed in acetone for 1 h and then dried before use.

When the silicon wafer was a porous silicon wafer, the porous silicon wafer was contacted with VBA and irradiated UV, where a total exposure time of about 400 s was used. For all samples, exposure times over 100 s consisted of sequential 100-s irradiations with intermediate pauses to avoid excessive heating. In addition, this reaction could be performed in a dilute system as to conserve the VBA. A g-VBA surface could be made using a 10% (v/v) solution of VBA in o-xylene (rather than “neat”) by the UV-hydrosilylation method, albeit with longer UV exposure time. Solvent choice must be carefully considered since the solvent should possess the following properties: being able dissolve the VBA effectively, exhibiting no reactivity with the H-terminated silicon surface during the UV exposure, and also being relatively low in volatility to avoid evaporation.

In regard to thermally-induced attachment, a 10% (v/v) solution of VBA in o-xylene was degassed via 3 freeze-pump-thaw cycles in a custom-made Schlenk flask. The flask was then backfilled with nitrogen gas to provide an inert atmosphere. The freshly etched H-terminated silicon sample was added to the flask being submerged into the solution; this step is also performed under nitrogen atmosphere. The flask was then sealed and protected with a slow stream of nitrogen with a bubbler before being submerged in an 80° C. oil bath. After allowing the VBA to react thermally with the surface for usually 24 hours, the sample and solution were allowed to cool to room temperature. The sample was then soaked/rinsed with o-xylene to remove unbound material. (Note: although theoretically the thermal route could be performed without solvent (neat), due to the inherent risk of explosion/instability of many organic azides, this reaction is safer in a more dilute system as described here.)

### EXAMPLES

Now having described the embodiments of the disclosure, in general, the examples describe some additional embodiments. While embodiments of the present disclosure are described in connection with the example and the corresponding text and figures, there is no intent to limit embodiments of the disclosure to these descriptions. On the contrary, the intent is to cover all alternatives, modifications, and equivalents included within the spirit and scope of embodiments of the present disclosure.

### Example 1

In this example, a straightforward method to attach an organic azide to H-terminated silicon surfaces by a one-step hydrosilylation approach using 4-vinylbenzyl azide (VBA) is presented for use in CuAAC click chemistry. In addition to traditional CuAAC click chemistry, this grafted VBA (g-VBA) surface also allows utilization of copper-free click chemistry, a technique that leverages ring-strained alkynes to alleviate the need to include catalysts such as copper, for surface attachment.¹⁰ To demonstrate the presence of the attached azide and its usefulness for both of these variations of click chemistry, the reactions between a collection of alkynes with the g-VBA surface were conducted and their products were analyzed by FTIR, water contact angles, and ellipsometry.

Typically, azide-terminated monolayers are attached to silicon surfaces via siloxane chemistry^{8,11,12} or via a multi-step modification of an existing hydrosilylation-derived monolayer.¹³ For example, Zheng et al., Heise et al., and Balachander et al. all demonstrated the modification Si/SiO₂ substrates with various bromide-terminated alkyltrichlorosilane compounds and subsequent conversion to azide-terminated monolayers via substitution with sodium azide.^{8,14,15} Meanwhile Paoprasert et al. and Vos et al. formed azide-terminated monolayers directly onto Si/SiO₂ substrates using azide-terminated trimethoxysilane molecules that were deposited through a vapor or solution-phase process, respectively.^{11,12} In contrast, others have investigated approaches that employ more hydrolytically stable Si—C linkages to form monolayers and to provide sites for further modification via copper(I)-catalyzed azide alkyne cycloaddition (CuAAC) and also copper-free click reactions. The method of grafting vinyl compounds from silicon utilizing a UV-induced silicon-carbon linkage has been demonstrated by the Buriak and Chidsey groups, among others.¹⁶⁻²³ As compared to Si—O—Si linkages, Si—C linkages are more stable and less susceptible to failure in aqueous environments as they avoid the hydrolytic instability associated with Si—O—Si linkages.²⁴⁻²⁷ Gouget-Laemmel et al. demonstrated formation of azide-terminated films from silicon by first attaching undecylenic acid by hydrosilylation and then converting this acid-terminated monolayer to a NHS ester using EDC coupling before finally obtaining the desired azide functionality by reaction with an azido-PEG8-amine compound.¹³ While the method presented by Gouget-Laemmel et al. was successful, their multi-step approach is more complicated than the more “straight-forward” approach to obtain azide-modified silicon via hydrosilylation that we demonstrate here.

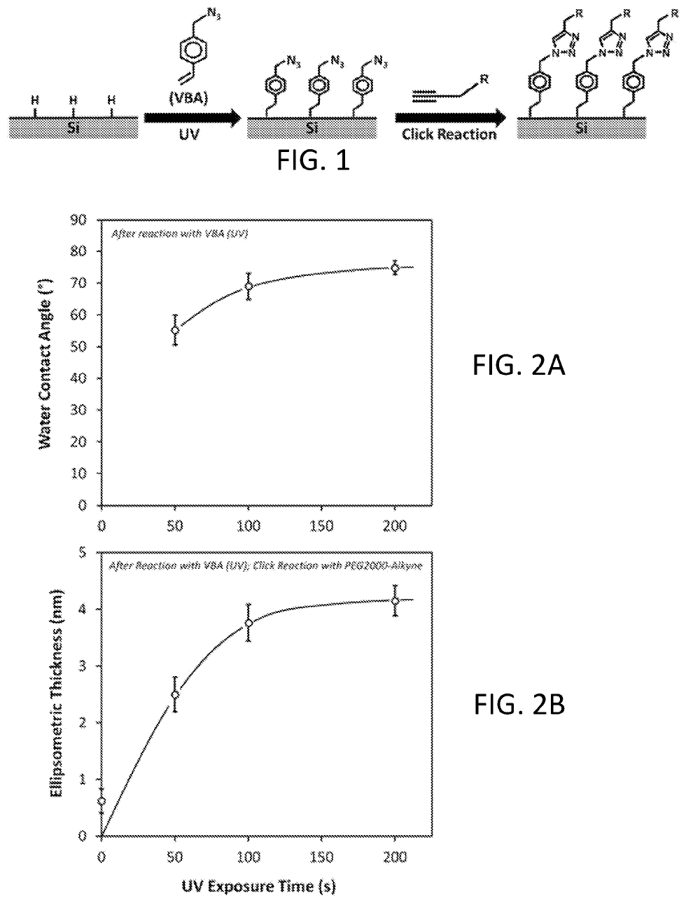

FIG. 1 illustrates the general scheme for the route presented in this example for covalently attaching an organic azide to a H-terminated silicon substrate via a one-step, UV-induced hydrosilylation reaction. In addition to flat silicon substrates, we attached VBA to porous silicon (PSi) substrates where the inherent high surface area of PSi provided higher signals for FT-IR analysis. Porous silicon (PSi) also provides a useful platform for sensing applications. Porous silicon has been demonstrated to be a highly effective platform for sensing applications as the presence of captured target molecules can be quantified via analysis of changes in position of interference fringes obtained through reflectance experiments.²⁸ The biotin-streptavidin interaction system represents one of the most common coupling strategies for binding bioreceptor systems to surfaces for capturing analytes in biosensing applications.²⁸⁻³³ To demonstrate the potential utility of the azide-modified porous silicon samples for biosensing applications, we demonstrated biotinylation of the substrates using a copper-free click reaction between an alkyne-containing biotin compound and the g-VBA surface.

### Experimental:

Chemicals and Materials: 4-Vinylbenzyl chloride, propargyl bromide (80% soln. in toluene), sodium hydride (60% dispersion in mineral oil), dibenzocyclooctyne-PEG4-biotin conjugate (DBCO-PEG4-biotin), N,N,N′,N″,N″-pentamethyldiethylenetriamine (PMDETA), potassium carbonate, 4-hydroxybenzaldehyde, and copper(II) sulfate pentahydrate were purchased from Sigma-Aldrich and used as received. Sodium azide, N,N-dimethylpropargylamine, 1,3-propanesultone, sodium ascorbate (NaAsc), and polyethylene glycol monomethyl ether 2000 (PEG2000) were purchased from TCl and used as received. 5-Hexynoic acid was purchased from Acros Organics and used as received. Single-sided polished, boron-doped, p-type silicon wafers ( [symbol] 100 [symbol] , 0.01-0.02 Ωcm, 500-550 μm) were purchased from Pure Wafer Inc.

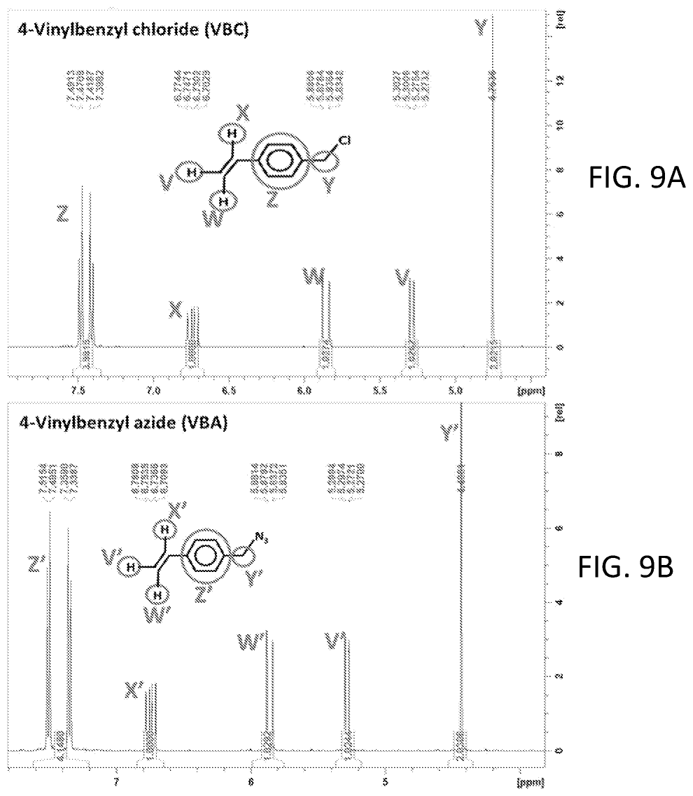

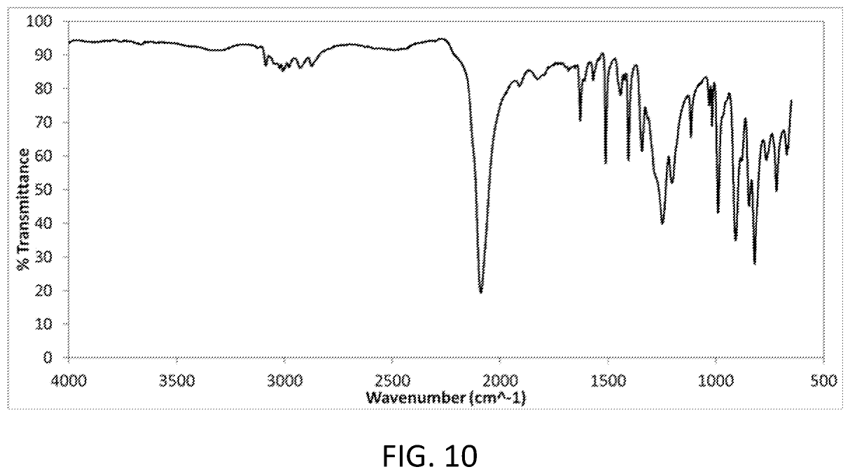

4-Vinylbenzyl Azide (VBA). This synthesis was conducted in a manner similar to that described previously.³⁴ 4-Vinylbenzyl chloride (0.84 mL, 6 mmol) was added dropwise with stirring to a solution containing 1.95 g (30 mmol) of sodium azide in 7.5 mL of anhydrous DMF. After stirring for 2 days, the solution was combined with 30 mL of DI water and then extracted with diethyl ether (3×30 mL). The ether phases were combined, washed with DI water (3×100 mL), and was dried over sodium sulfate. Concentration by rotary evaporation provided the title compound as a light-yellow oil in 80% yield. NMR and FTIR spectra are provided as FIGS. 9 and 10. ¹H-NMR (400 MHZ, DMSO-d₆) δ/ppm=7.52-7.50 (m, 2 H, ArH), 7.36-7.34 (m, 2 H, ArH), 6.75 (dd, 1 H, J=17.7 Hz, J=10.9 Hz, Ar—CH═CH₂), 5.8 (dd, 1 H, J=17.7 Hz, J=0.9 Hz, Ar—CH═CH₂), 5.28 (dd, 1 H, J=10.9 Hz, J=0.8 Hz, Ar—CH═CH₂), 4.44 (s, 2H, Ar—CH₂—N₃). Sodium azide (NaN₃) is known to present an explosion hazard. Exposure to halogenated solvents or some organohalides can lead to the formation of explosive organic azides. Sodium azide can also react with water to form hydrazoic acid, a toxic and explosive gas. Sodium azide should be handled with non-metal utensils to prevent formation of unintended shock-sensitive products. To further minimize potential risks, it is recommended that synthesis of organic azides are conducted in small batch sizes as the organic azides can also be explosion hazards. Appropriate safety protocols should be established before attempting any synthesis involving sodium azide or its derivatives.

Porous Silicon: Si wafers were sequentially washed with acetone, isopropanol, and ethanol, and then dried with nitrogen before use. A layer of PSi was formed by electrochemical etching Si in a 15% HF solution in ethanol at a current density of 70 mA/cm² for 100 s. The substrates were then thoroughly washed with ethanol and dried with nitrogen. The PSi layer was 3.65 μm thick and had a porosity of 80%.

Methoxy-PEG2000-propyne. This synthesis was conducted based on that described by Zill et al.³⁵ In a round-bottom flask, 5.0 g (2.5 mmol) of polyethylene glycol monomethyl ether (average M.W. ˜2000) was added, sealed via septum, and sparged with N₂ for approximately 30 min before adding 100 mL of anhydrous THF. In a separate flask, 0.1 g of NaH (2.5 mmol, 60% dispersion in mineral oil) was added along with a stir bar, and sparged with N₂ for approximately 30 min before adding 35 mL of anhydrous THF. The NaH/THF solution was chilled over ice bath before adding the PEG2000/THF solution via cannula transfer dropwise and with stirring. After 30 min, 0.334 mL of propargyl bromide (3.0 mmol, 80% solution in toluene) was added dropwise to the solution with stirring over an ice bath. The reaction solution was then allowed to warm to room temperature and react overnight. The solution was then gravity filtered, rinsing the filter paper with DCM. The filtrate was diluted with 75 mL of DI water and the solution was extracted 3× with 75 mL of DCM. The organic layers were combined and then concentrated to approximately 25 mL via rotary evaporation before precipitating into 250 mL of cold ether overnight in a freezer. The product was collected via filtration to obtain a 74.9% yield.

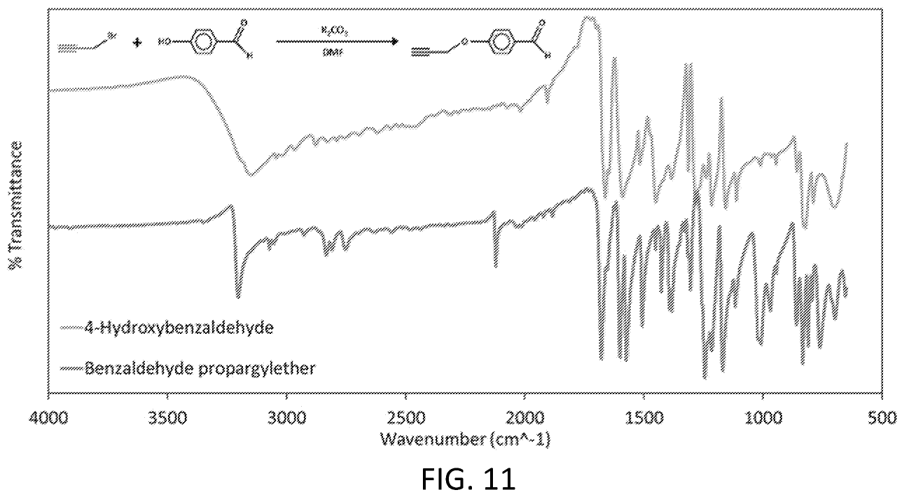

3-[Dimethyl(2-propyn-1-yl)ammonio]-1-propanesulfonate (SB-Alkyne): In a round-bottom flask, 0.5 mL (4.6 mmol) of n,n-dimethylpropargylamine was dissolved in 5 mL of dry acetone. In a separate round-bottom flask 0.44 mL (5.0 mmol) of 1,3-propanesultone was dissolved 5 mL of dry acetone. Both solutions were sparged with nitrogen before transferring the 1,3-propanesultone solution to the N,N-dimethylpropargylamine solution dropwise over 30 min with stirring. The reaction was allowed to proceed for 18 h and the solid product was collected via filtration, washing with acetone to obtain 68.4% yield 4-(Prop-2-ynyloxy)benzaldehyde. This synthesis was conducted based on that described by Darroudi et al.36 In a round-bottom flask, 0.611 g (5 mmol) of 4-hydroxybenzaldehyde and 0.691 g (5 mmol) of potassium carbonate were dissolved in 15 mL of anhydrous DMF. With stirring, 0.668 mL (6 mmol) of propargyl bromide solution (80% wt. in toluene) was added dropwise. The reaction was allowed to proceed for 24 hours before precipitating the product into 40 mL of deionized H₂O. The product was collected via filtration, washed very thoroughly with water, and dried via vacuum. The product was an off-white powder with a yield of 66.2%. FTIR spectra of the product is available in supporting information (FIG. 11).

Attachment of VBA via Hydrosilylation: For modification of flat silicon, 1×1 cm² samples were placed in an 800° C. oven for 4 h. After cooling, the samples were soaked in a 2.5% aq. HF solution to remove the oxide, rinsed with DI water, and dried. For irradiation, samples consisted of 15 μL of VBA sandwiched between the silicon surface and a No. 1 thickness coverslide. Samples were irradiated with UV light in a DYMAX 5000-EC UV curing lamp system. Total exposure times were typically 200 s. After removal of the coverslides, the samples were immersed in acetone for 1 h and then dried before use.

For modification of porous silicon: Porous silicon samples were similarly soaked in aq HF as for flat silicon, but rinsed with water and then ethanol before drying. They were similarly contacted with VBA and irradiated UV, except that a total exposure time of 400 s was used.

For all samples, exposure times over 100 s consisted of sequential 100-s irradiations with intermediate pauses to avoid excessive heating.

CuAAC Reactions with VBA

For VBA-modified porous and flat silicon samples reacted with SB-alkyne: A VBA-modified sample and 10 mg of SB-alkyne were placed in a vial, sealed via septum, and sparged with nitrogen. A solution containing 8 mg of CuSO₄·5H₂O and 6.3 μL of PMDETA in 5 mL of deionized H₂O was produced and sparged with nitrogen. A second solution containing 12 mg of sodium ascorbate in 5 mL of deionized H₂O was produced and sparged with nitrogen. Both solutions (1 mL each) were then injected into the slide-containing vial to start the click reaction. Concentrations in the final reaction solution were as follows: SB-alkyne (25 mM), CuSO₄·5H₂O (3 mM), PMDETA (3 mM), NaAsc (6 mM). After 18 h reaction completion, samples were soaked in water for 24 hours to remove unbound material, rinsed with EtOH, and dried with nitrogen.

For VBA-modified samples reacted with 4-(prop-2-ynyloxy)benzaldehyde: This process was the same as for SB-alkyne, except 8 mg (25 mM in final solution) of 4-(prop-2-ynyloxy)benzaldehyde was placed in each vial. Additionally, the reaction solvent was a 50/50 mix of ethanol and water, rather than just water as with SB-alkyne experiments.

For VBA-modified samples reacted with PEG2000-alkyne: This process was the same as for SB-alkyne, except 50 mg of PEG2000-alkyne was placed in each vial resulting in a final concentration of 12.5 mM of the alkyne. Additionally, the reaction solvent was a 50/50 mix of ethanol and water, rather than just water as with SB-alkyne experiments.

For VBA-modified porous silicon samples reacted with 5-hexynoic acid: A 100 μL solution containing 5-hexynoic acid (85 mM), CuSO₄·5H₂O (3 mM), PMDETA (3 mM), and sodium ascorbate (6 mM) in a 1:1 EtOH:H₂O mixture was dispensed onto the surface of a VBA-modified porous silicon slide and covered to prevent evaporation of solvent. After 18 h reaction, the samples were removed from reaction mixture then soaked for 24 h in 1:1 EtOH/H₂O (v/v) to remove unbound material, rinsed with EtOH, and then dried with nitrogen

Biotinylation of g-VBA Surfaces via Copper-free Click Chemistry: To modify g-VBA surfaces with biotin via copper-free click chemistry, a 20 mM solution of DBCO-PEG4-biotin in DMSO was dispensed onto the g-VBA surface, covering the sample. The samples were then allowed to react with the DBCO-PEG4-biotin solution at room temperature for 24 h. The samples were then rinsed with DMSO, ethanol, water, and again with ethanol before drying with a stream of nitrogen.

Analytical Techniques: Infrared data were obtained using a Thermo Nicolet 6700 FT-IR Spectrometer with Smart iTR™ Attenuated Total Reflectance (ATR) attachment with diamond crystal plate. Due to the need to clamp samples to the diamond crystal for analysis, this method is destructive to PSi surface; thus measurements taken after each reaction step were taken at different locations, albeit on the same sample.

Film thicknesses were measured using an M-2000VI spectroscopic ellipsometer (J.A. Woollam Co.). Each sample was measured at angles of incidence of 60° and 70°. CompleteEASE software was used to analyze the measurements using the built-in transparent Cauchy film on silicon substrate model. A refractive index of 1.45 was assumed.

Advancing and receding water contact angles were measured on static drops with the dispensing needle remaining in the drop using a Rame Hart goniometer.

### Results and Discussion:

### Synthesis of VBA and Optimizing Attachment to Flat Silicon:

Although the synthesis of 4-vinylbenzyl azide and its attachment to H-terminated silicon as described here are quite simple and straightforward, one must still be aware of the hazards of working with sodium azide and organic azides in general as described in the Experimental section. The synthesis of VBA has been described previously for its use as a monomer to introduce azide groups in styrene-based copolymers34.37,38; however, it has not been used to create monolayer coatings such as those described here. Once the liquid VBA compound has been synthesized, an azide-modified silicon substrate can be made in a single reaction step in just a matter of minutes. To do so, the liquid was simply deposited onto H-terminated silicon wafers, covered with a coverslip, and then exposed to a UV source. As each UV-source's power and emission spectrum along with the coverglass's thickness and material (i.e. glass vs quartz) will all likely impact the hydrosilylation reaction progress differently, it is likely necessary to determine an ideal UV-exposure time for one's individual setup. To determine these ideal conditions, water contact angles on the g-VBA samples and subsequent thickness after click reaction were examined.

With our DYMAX 5000-EC UV curing lamp system and No. 1 thickness glass coverslides, we determined 200 s to be appropriate. The resulting samples modified with VBA produced via this UV hydrosilylation technique resulted in films with water contact angles of approximately 75°, consistent with literature reports for azide-terminated monolayers. 11.39 As evident in FIG. 2, shorter exposure times (50 s and 100 s) were also examined, but these conditions resulted in water contact angles less than that expected of an azide coating, suggesting incomplete substrate coverage. Longer times yielded minimal change in water contact angle or thickening/hardening of the VBA liquid (likely a polymerization process) that would result in the coverglass becoming stuck to the sample surface, and thus were avoided.

Subsequently, modification of g-VBA surfaces with PEG2000-alkyne via Click reaction on flat silicon was examined to further assess the effect of UV exposure time on the g-VBA surfaces. PEG2000-alkyne was chosen as this linear polyether's much larger molecular weight and resulting length, as compared to the other alkynes discussed later, produced coatings of ample thickness as to more easily be evaluated via ellipsometry. As shown in FIG. 2, the ellipsometric thickness of the added PEG was 4.2±0.3 nm after 18 h reaction for g-VBA slides produced with 200 s exposure. Shorter exposure times resulted in the grafted PEG thickness being lower, further consistent with a lesser availability of azide sites due to lesser or incomplete substrate coverage. Based upon a trans-extended PEG repeat-unit length of 0.358 nm and its average molecular weight of 2000 g/mol, a total PEG-length of around 16 nm can easily be estimated which represents the maximum theoretical thickness of a PEG2000-derived monolayer.⁴⁰ As PEG has a tendency to exist in an amorphous form or in a helical conformation rather than trans-extended unless very closely packed⁴¹, PEG2000-derived monolayers reported in literature tend to be a fraction of this amount.^{42,43} For a helical PEG with a repeat-unit length of 0.278 nm and average molecular weight of 2000 g/mol, a total PEG-length of around 12.5 nm can be estimated which represents a maximum theoretical thickness more applicable to the kind of PEG2000-derived monolayer desired in this experiment.⁴² Based upon the obtained thickness of 4.2 nm and an assumed density of 1 g/cm³, the grafting density can be estimated to be approximately 1.3 molecules/nm². Based upon the assumption that for each individual PEG2000-alkyne molecule attached to the surface during the Click corresponds to an available azide site, this suggests that azide coverage must have been at least 1.3 molecules/nm² also. As PEG2000-alkyne represents a fairly large molecule, the inability to reach the theoretical thickness may have resulted from steric limitations. Also of note, little difference in water angles of the PEG-grafted samples was observed after the modification of the g-VBA samples prepared with different exposure times, with all water contact angles being in the 30-40 degree range. This decrease in water contact angle from the 75° of a g-VBA surface before click reaction is consistent with successful conversion of azide-modified silicon surface to a PEG-modified surface. Further, these water contact angles are consistent with PEG modified surfaces shown in literature.⁴⁴

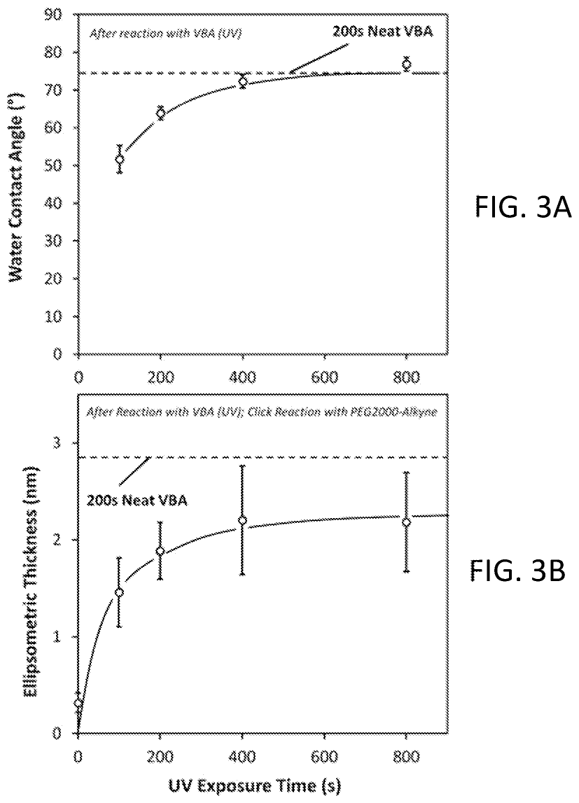

To evaluate whether g-VBA modified silicon surfaces could be obtained using dilute VBA solutions, as opposed to the “neat” VBA discussed above, we repeated the same experiments except with the VBA diluted in a solvent during the UV-exposure step. Being able to obtain g-VBA surfaces from dilute VBA solutions would reduce VBA consumption during the preparation of the samples. Solvent choice was important here as the desired solvent needed to possess the following properties: being able dissolve the VBA effectively, exhibiting no reactivity with the H-terminated silicon surface during the UV exposure, and also being relatively low in volatility to avoid evaporation. Xylene was found to fit these needs, and 10% (v/v) solutions of VBA in o-Xylene were utilized for the UV-hydrosilylation step. FIG. 3 shows the water contact angles of g-VBA surfaces prepared with different exposure times and also the thickness of PEG2000-Alkyne clicked to each of the different surfaces. Also included were controls where o-Xylene was introduced to the H-terminated silicon surface with VBA omitted during the UV exposure step. Further included for reference were g-VBA surfaces prepared from “neat” VBA. As seen in FIG. 3, increasing the exposure time resulted in higher water contact angles for the g-VBA modified surface by this dilute method, with exposure times of 400 s and longer comparable to that of the “neat” g-VBA samples. The shortest exposure (100 s) exhibited the lowest water contact angle as seen in FIG. 3, being similar to that of the VBA-omitted controls (50±3° for 200 s; 45±3° for 800 s). After click reaction with PEG2000-alkyne, all of the g-VBA samples prepared from dilute VBA solutions possessed PEG coating thicknesses much greater than that measured for the controls (0.4±0.3 nm for 200 s; 0.2±0.1 nm for 800 s), which had no reactive azide sites available for attachment via click chemistry. What little increase in thickness that was observed for the controls after exposure to the click solution was likely due to oxidation of the Si surface to a thin layer of SiO₂. Even after 800 s of UV exposure, the g-VBA samples produced by this dilute method were unable to produce PEG coating thicknesses matching that of those prepared via the “neat” VBA method. Like the PEG coatings produced from “neat” g-VBA samples, little difference was observed in the water contact angles of the PEG-grafted “dilute” g-VBA substrates with different exposure times, with all water contact angles being in the 30-40° range. Based upon these results, using “neat” VBA solutions and 200 s of UV exposure to produce the g-VBA silicon substrates was determined to be the most ideal preparation conditions.

### Attachment of VBA to Porous Silicon for FTIR Analysis:

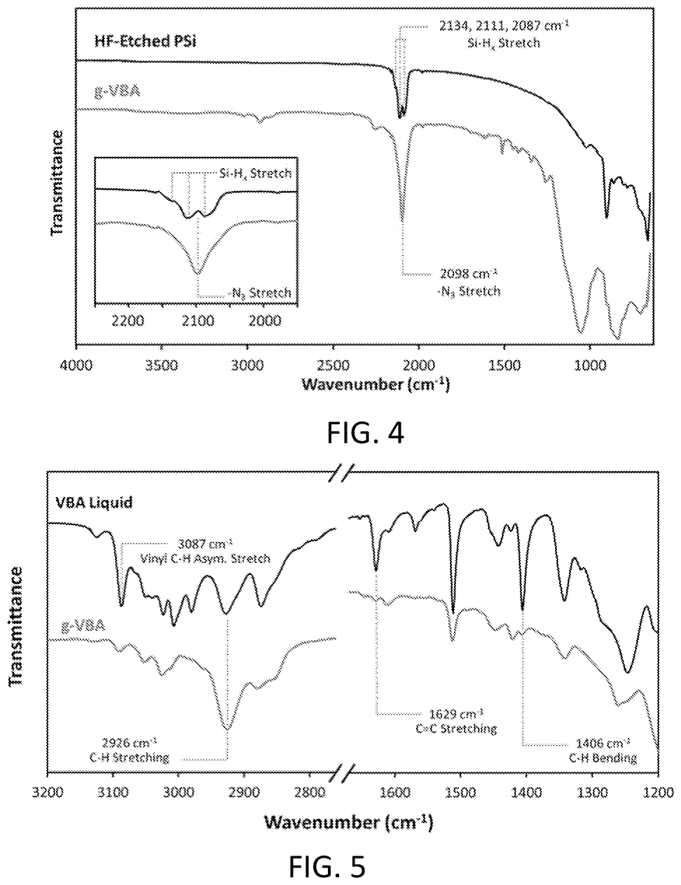

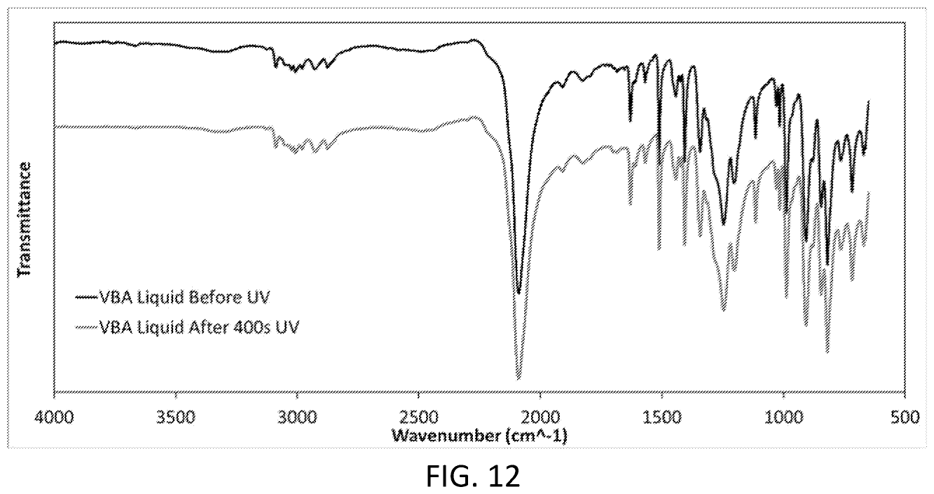

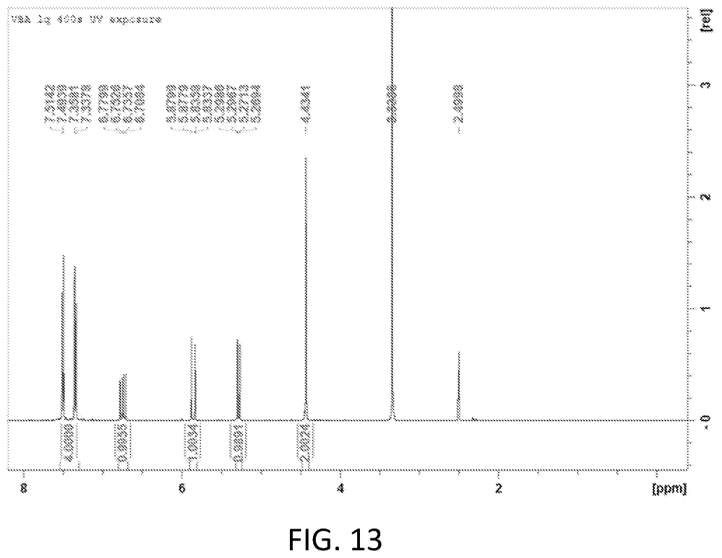

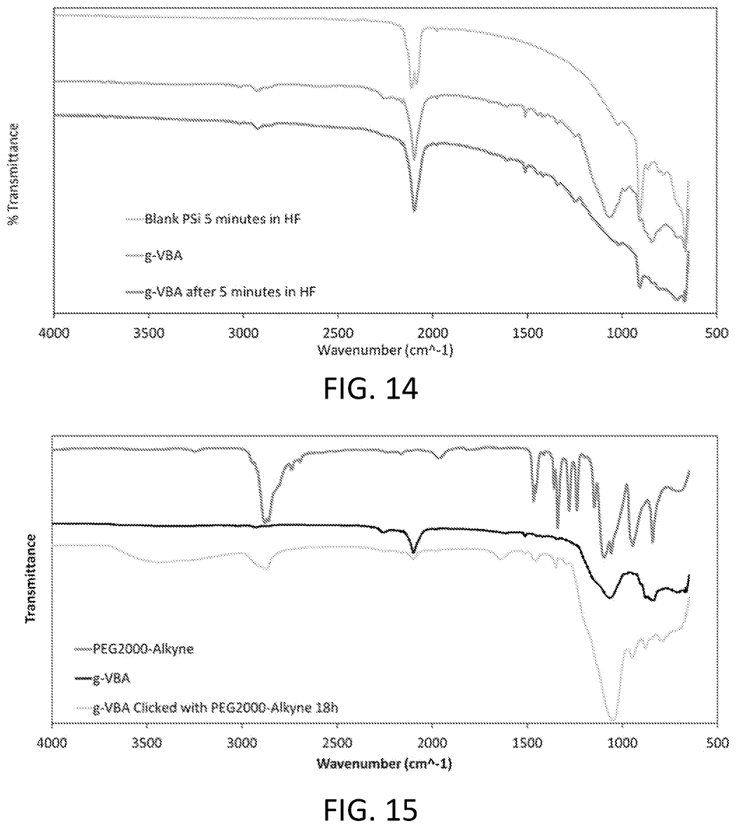

Another strategy to verify the presence of the surface-bound azide moeities on silicon samples by this hydrosilylation process is via infrared analysis. Coatings on flat silicon were much too thin to be analyzed via FTIR. To increase the measurable IR signal of these surface modifications, the same VBA coating strategy was also applied to H-terminated porous silicon (PSi) to take advantage of the much higher surface area available for modification. As shown in FIG. 4, the appearance of the sharp peak at 2098 cm⁻¹ characteristic of —N₃ stretching suggests successful attachment of VBA to the PSi substrate. FIG. 5 shows a comparison of the FTIR spectra of g-VBA samples to that of liquid VBA. The loss in intensity of the peak at 3087 cm⁻¹ attributed to C—H asymmetric stretching at the vinyl group after UV surface treatment as compared to the pure VBA liquid, is consistent with successful attachment of VBA via hydrosilylation. Further, the relative increase in intensity of the peak at 2926 cm⁻¹ associated with antisymmetric C—H stretching due to the vinyl group converting to methylene groups upon hydrosilylation further supports successful attachment of VBA. The loss of the peaks at 1629 and 1406 cm⁻¹ attributed to C═C stretching and C—H bending, respectively, of the vinyl group after UV surface treatment as compared to the pure VBA liquid, is once again consistent with successful attachment of VBA via hydrosilylation. To ensure the loss of the peaks assigned to the vinyl group did simply not occur as a result of a UV-induced polymerization/oligimerization of the liquid VBA, a sample of the liquid was exposed to the same UV source for 400 s and analyzed via FT-IR (see FIG. 12). The spectrum for the UV-irradiated VBA displayed no changes, particularly those that would be associated with loss of a vinyl group due to polymerization, further supporting that the spectral changes observed at the VBA-grafted surface are due to successful attachment of VBA via hydrosilylation. Further, NMR spectra collected for VBA before and after 400 s of UV-irradiation also showed no change (see FIG. 13). The stability of these g-VBA films on PSi was also assessed by exposure to an aqueous 2.5% HF solution. In the FTIR spectrum of the resulting HF-exposed sample (FIG. 14), only signal associated with SiO₂ was diminished, with the grafted VBA clearly remaining present on the substrate.

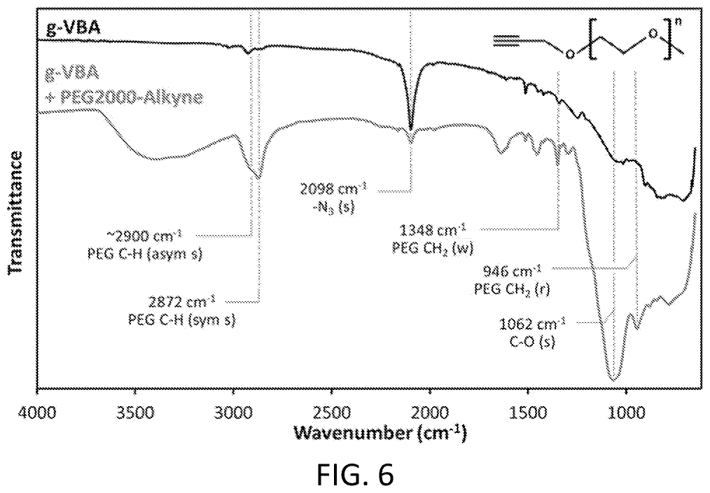

Looking at the same reaction on a porous silicon surface, g-PSi-VBA surfaces were allowed to react in the PEG2000-alkyne click solution for 18 h. FIG. 6 shows the FTIR spectra before and after click reaction with PEG2000-alkyne. Appearance of the peak at 1062 cm⁻¹ characteristic of C—O stretching of ethers suggests some conversion of the g-VBA substrate to form a PEG-modified surface. It is worth noting that Si—O stretching appears in the same region of FTIR spectra as the C—O stretching of PEG, and thus is difficult to differentiate here. For further evidence of added PEG moieties, the shoulder at approximately 2900 cm⁻¹ and the peak at 2872 cm⁻¹, assigned to the C—H asymmetric and C—H symmetric stretches respectively of the PEG's methylene groups, demonstrates conversion of azide sites with PEG2000-alkyne. Further, the appearance of the 1348 and 946 cm⁻¹ peaks characteristic of PEG moieties suggests successful incorporation of the PEG2000-alkyne.⁴¹ In addition, the 2098 cm⁻¹ peak assigned to —N₃ stretching of the azide groups of the g-PSi-VBA surface has diminished, further consistent with conversion of some of the surface azide moieties to the desired PEG2000 moieties. As with the click reactions performed on flat substrates, the FTIR spectra suggests that complete conversion was, once again, not achieved as evidenced by the azide peak not being fully diminished after the reaction. Due to the large size of the approximately 2000 molecular weight PEG compound, steric limitations may have played a role in the lack of full conversion. Samples were also allowed to react for 48 h, but these did not show evidence of further reaction as compared to 18 h samples. A comparison of these spectra with that of bulk PEG2000-alkyne powder is found in FIG. 15.

### Other CuAAC Click Reactions on Azide-Grafted Porous Silicon:

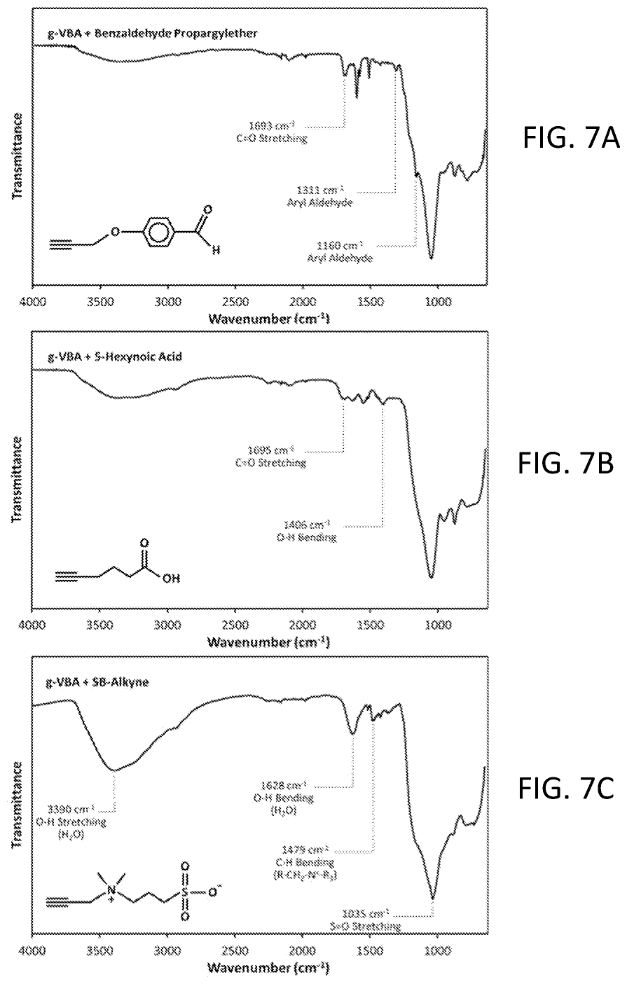

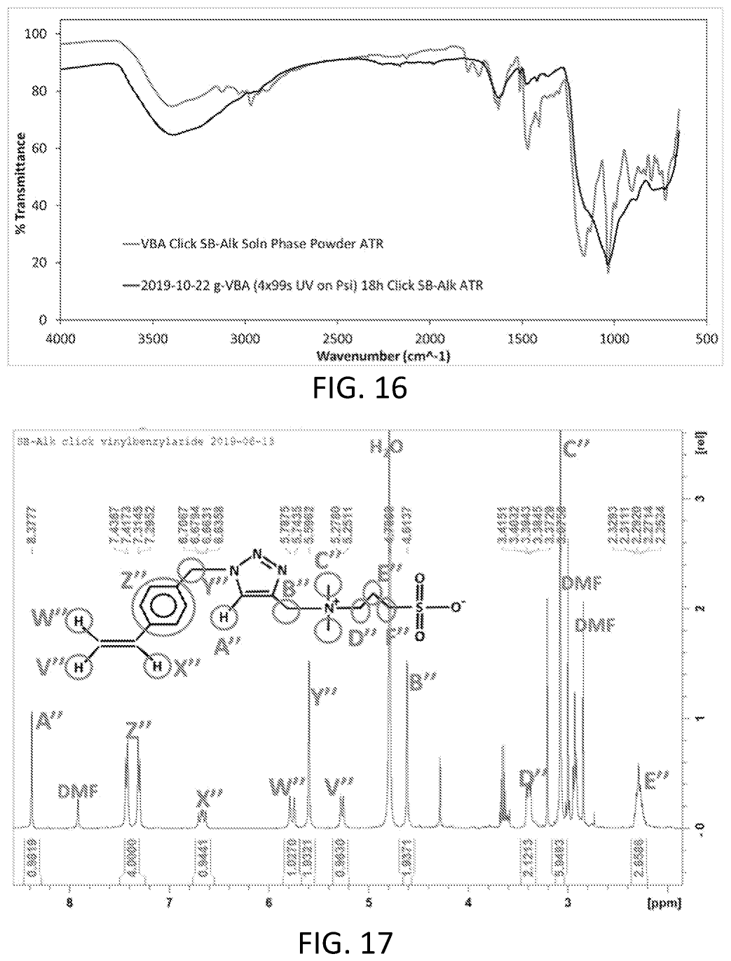

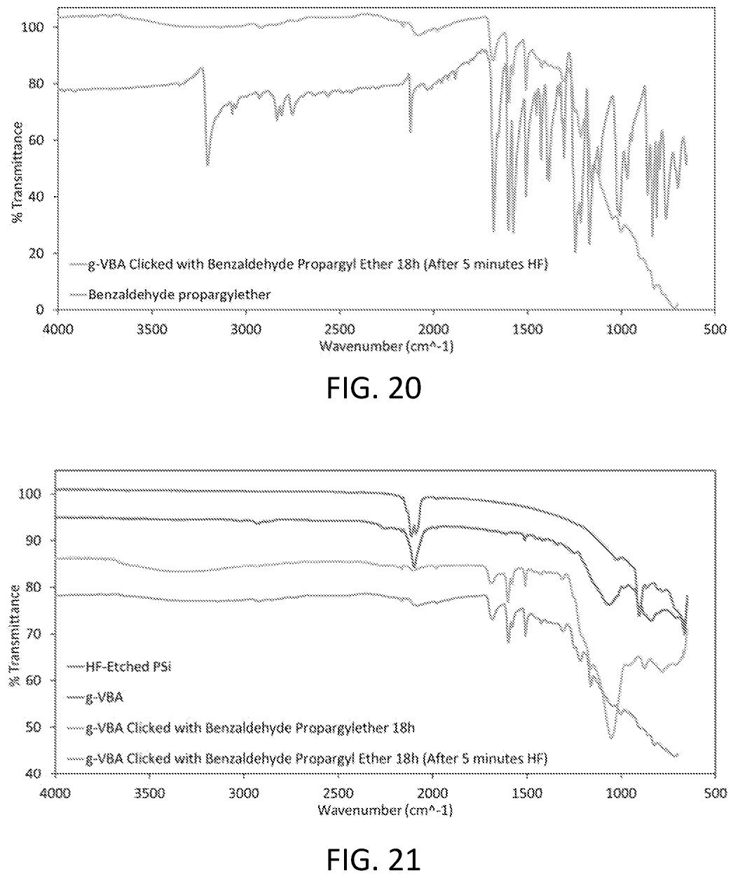

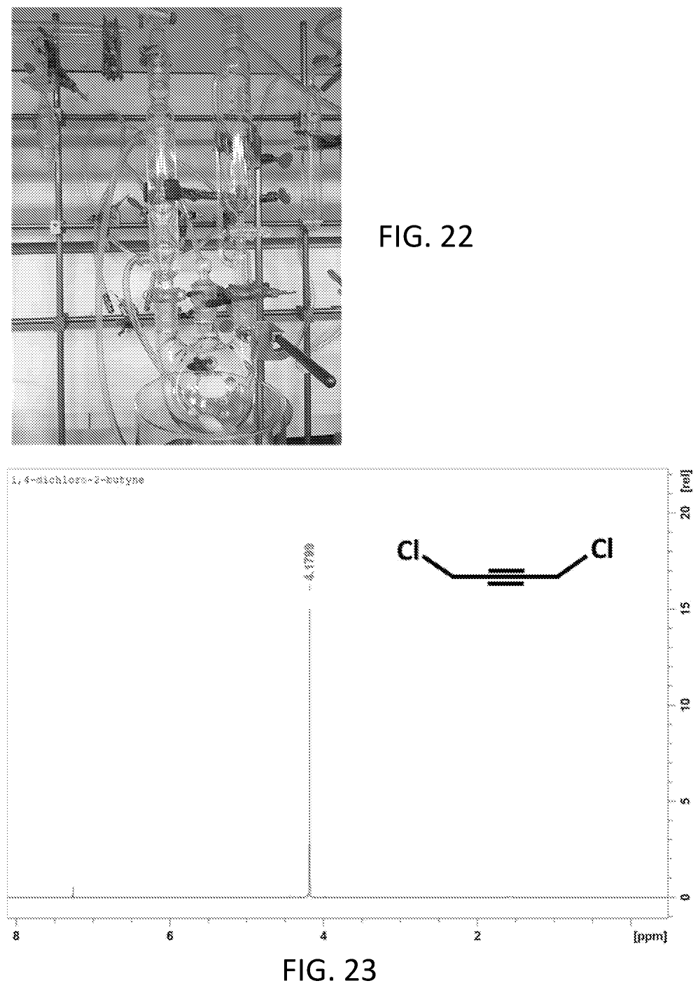

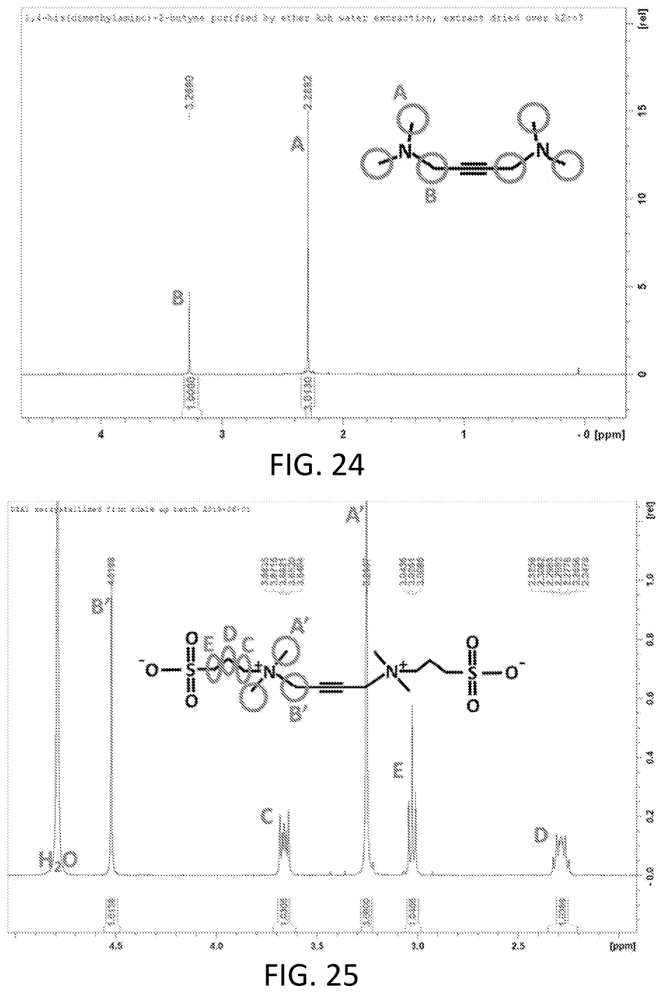

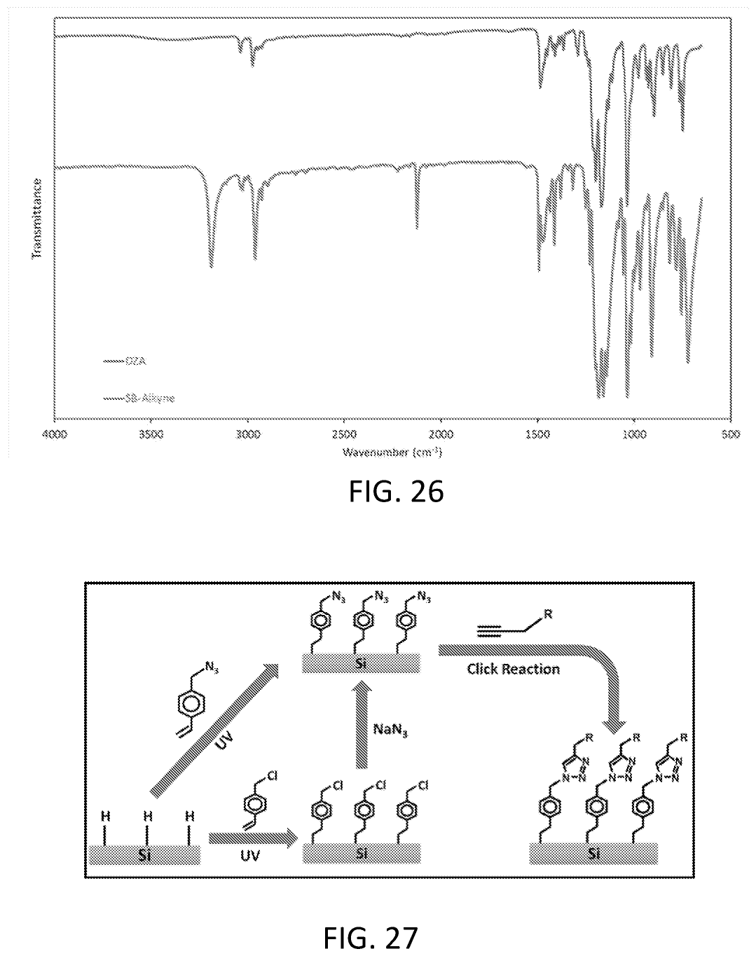

Upon 18 h click reaction of SB-alkyne with the PSi-g-VBA surface, appearance of the peak at 1479 cm⁻¹ commonly associated with C-H bending of methyl groups of the quaternary nitrogen of the zwitterionic group was observed as shown in FIG. 7A-C.⁴⁵⁻⁴⁹ Adsorbed water on the hydrophilically-modified surface and oxidation of the silicon (creating surface Si—OH hydroxyl groups) could both contribute to the broad peak centered at 3390 cm⁻¹ and the peak at 1628 cm⁻¹ assigned to O—H stretching and bending respectively. The sharp peak at 1035 cm⁻¹, which protrudes from the broader Si—O stretching in the same region, corresponds to S═O stretching of the sulfobetaine group. The loss of the azide peak at 2098 cm⁻¹ and the absence of peaks at 3189 and 2123 cm⁻¹ associated with the C—H stretching and CEC stretching, respectively, of the alkyne group further suggests successful attachment of SB-alkyne through triazole formation. A comparison of this FT-IR spectrum to that of VBA reacted with SB-alkyne in the solution phase is found in FIG. 16. Further, NMR spectra of VBA reacted with SB-alkyne in the solution phase demonstrated successful click reaction and is also found in supporting information (FIG. 17). With the successful click reaction of SB-alkyne, a novel symmetric dual zwitterionic alkyne (DZA) was synthesized in an effort to increase density of zwitterionic groups clicked to the g-VBA surfaces as compared to SB-alkyne. However, click reaction attempts with DZA proved unsuccessful; a summary of the synthesis of the novel DZA is found in the “Dual Zwitterionic Alkyne Experiments” section of Supporting Information (e.g., FIGS. 19-26).

Upon 18 h click reaction of 5-hexynoic acid with the PSi-g-VBA surface, appearance of peaks at 1695 and 1406 cm⁻¹ associated with C═O stretching and OH bending of the carboxylic acid were observed. Once again, adsorbed water on the hydrophilically-modified surface and oxidation of the silicon (creating surface Si—OH hydroxyl groups) could both contribute to the broad peak centered at 3390 cm⁻¹ and the peak at 1628 cm⁻¹ assigned to O-H stretching and bending respectively. The loss of the azide peak at 2098 cm⁻¹ and the absence of the peaks at 3295 and 2118 cm⁻¹ associated with the C—H stretching and CEC stretching respectively of the alkyne group further suggests successful attachment of 5-hexynoic acid through triazole formation.

Upon 18 h click reaction of 4-(prop-2-ynyloxy)benzaldehyde (benzaldehyde propargylether) with the PSi-g-VBA surface, appearance of the peak at 1693 cm⁻¹ associated with C═O stretching and of the aldehyde group was observed. In addition, peaks at 1160 and 1311 cm⁻¹ characteristic of aryl aldehydes were observed.⁵⁰ The loss of the azide peak at 2098 cm⁻¹ and the absence of the peaks at 3203 and 2122 cm⁻¹ associated with the C—H stretching and CEC stretching respectively of any unreacted alkyne group further suggests successful attachment of benzaldehyde propargylether by click chemistry.

Copper-free Click Reactions with Azide-Grafted Porous Silicon for Biotinylation:

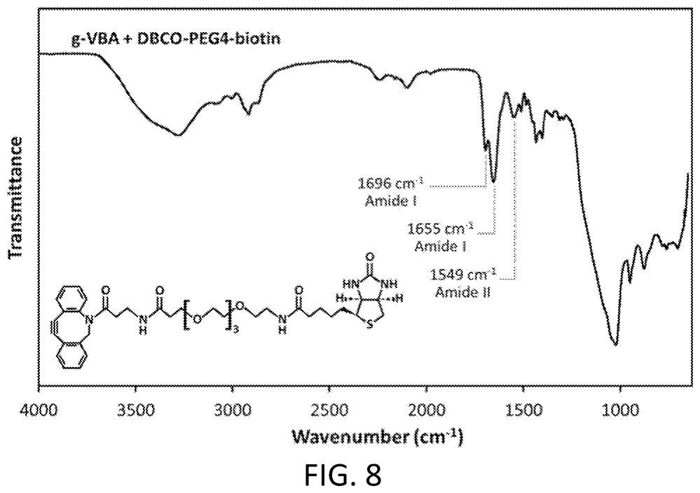

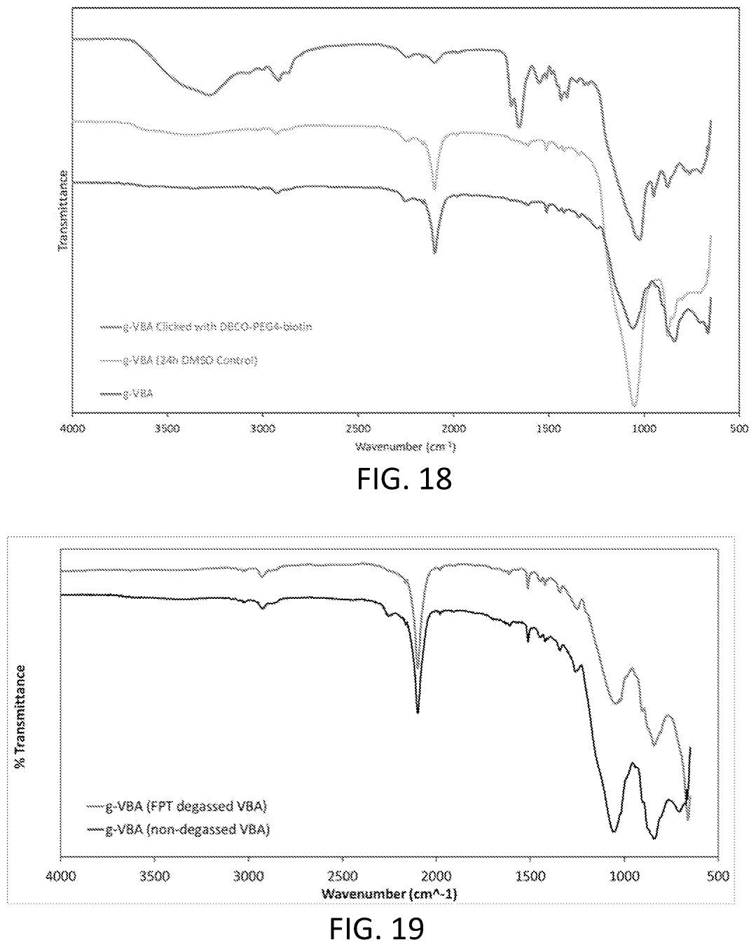

Upon 24 h click reaction of DBCO-PEG4-biotin with the PSi-g-VBA surface in DMSO, appearance of peaks at 1696 and 1655 cm⁻¹ associated with the Amide I bands of the cyclic urea group in biotin and the secondary amides, respectively, within the DBCO-PEG4-biotin structure were observed as shown in FIG. 8.⁵⁰ Further, the appearance of peak at 1549 cm⁻¹ can be assigned to the Amide II band for the attached DBCO-PEG4-biotin.⁵⁰ The reduced intensity of the azide peak at 2098 cm⁻¹ further suggests successful click attachment of DBCO-PEG4-biotin to the porous silicon surface. As a control, PSi-g-VBA surfaces were exposed to the same reaction solvent (DMSO) for 24 h, omitting only the DBCO-PEG4-biotin. As expected, no change to the azide peak was observed when the alkyne was omitted; the FTIR spectrum for this control experiment is found in FIG. 18.

### Conclusion

This work demonstrated successful attachment of an organic azide (VBA) to H-terminated silicon surfaces by a one-step UV-induced hydrosilylation method. In addition to flat silicon substrates, attachment of VBA to porous silicon (PSi) substates was performed and verified via FT-IR analysis. We further demonstrated the presence of the attached azide to PSi surfaces and its usefulness for click chemistry by “clicking” an assortment of alkynes to azide surface via both copper(I)-catalyzed azide alkyne cycloaddition (CuAAC) and also copper-free click chemistry using a ring-strained alkyne, verifying successful attachment via FTIR in each case. Biotinylation of the substrates was performed via the aforementioned copper-free click reaction between an alkyne-containing biotin compound and the g-VBA surface to demonstrate the potential utility of the azide-modified porous silicon samples for biosensing applications afforded by the porous substrate.

### REFERENCES FOR EXAMPLE 1

(1) Liang, L.; Astruc, D. The Copper(I)-Catalyzed Alkyne-Azide Cycloaddition (CuAAC) “Click” Reaction and Its Applications. An Overview. Coordination Chemistry Reviews. December 2011, pp 2933-2945. https://doi.org/10.1016/j.ccr.2011.06.028.
(2) Castro, V.; Rodríguez, H.; Albericio, F. CuAAC: An Efficient Click Chemistry Reaction on Solid Phase. 2015. https://doi.org/10.1021/acscombsci.5b00087.
(3) Neumann, S.; Biewend, M.; Rana, S.; Binder, W. H. The CuAAC: Principles, Homogeneous and Heterogeneous Catalysts, and Novel Developments and Applications. Macromolecular Rapid Communications 2020, 41 (1), 1900359. https://doi.org/10.1002/marc.201900359.
(4) Martens, S.; Holloway, J. O.; du Prez, Filip. E. Click and Click-Inspired Chemistry for the Design of Sequence-Controlled Polymers. Macromolecular Rapid Communications 2017, 38 (24), 1700469. https://doi.org/10.1002/marc.201700469.
(5) Arslan, M.; Tasdelen, M. A. Click Chemistry in Macromolecular Design: Complex Architectures from Functional Polymers. Chemistry Africa 2019, 2 (2), 195-214. https://doi.org/10.1007/s42250-018-0030-8.
(6) Arslan, M.; Tasdelen, M. A. Polymer Nanocomposites via Click Chemistry Reactions. Polymers. MDPI AG October 11, 2017. https://doi.org/10.3390/polym9100499.
(7) Yáñez-Sedeño, P.; González-Cortés, A.; Campuzano, S.; Pingarrón, J. M. Copper(I)-Catalyzed Click Chemistry as a Tool for the Functionalization of Nanomaterials and the Preparation of Electrochemical (Bio)Sensors. Sensors 2019, 19 (10), 2379. https://doi.org/10.3390/s19102379.
(8) Zheng, S.; Yang, Q.; Mi, B. Novel Antifouling Surface with Improved Hemocompatibility by Immobilization of Polyzwitterions onto Silicon via Click Chemistry. Applied Surface Science 2016, 363, 619-626. https://doi.org/10.1016/j.apsusc.2015.12.081.
(9) Li, N.; Binder, W. H. Click-Chemistry for Nanoparticle-Modification. https://doi.org/10.1039/c1jm11558h.
(10) Jewett, J. C.; Bertozzi, C. R. Cu-Free Click Cycloaddition Reactions in Chemical Biologyw. 2010. https://doi.org/10.1039/b901970g.
(11) Vos, R.; Rolin, C.; Rip, J.; Conard, T.; Steylaerts, T.; Cabanilles, M. V.; Levrie, K.; Jans, K.; Stakenborg, T. Chemical Vapor Deposition of Azidoalkylsilane Monolayer Films. 2017. https://doi.org/10.1021/acs.langmuir.7b04011.
(12) Paoprasert, P.; Spalenka, J. W.; Peterson, D. L.; Ruther, R. E.; Hamers, R. J.; Evans, P. G.; Gopalan, P. Grafting of Poly(3-Hexylthiophene) Brushes on Oxides Using Click Chemistry †‡. https://doi.org/10.1039/b920233a.
(13) Gouget-Laemmel, A. C.; Yang, J.; Lodhi, M. A.; Siriwardena, A.; Aureau, D.; Boukherroub, R.; Chazalviel, J.; Ozanam, F.; Szunerits, S. Functionalization of Azide-Terminated Silicon Surfaces with Glycans Using Click Chemistry: XPS and FTIR Study. 2012. https://doi.org/10.1021/jp309866d.
(14) Heise, A.; Menzel, H.; Yim, H.; Foster, M. D.; Wieringa, R. H.; Schouten, A. J.; Erb, V.; Stamm, M. Grafting of Polypeptides on Solid Substrates by Initiation of N-Carboxyanhydride Polymerization by Amino-Terminated Self-Assembled Monolayers. Langmuir 1997, 13 (4), 723-728. https://doi.org/10.1021/la960467g.
(15) Balachander, N.; Sukenik, C. N. Functionalized Siloxy-Anchored Monolayers with Exposed Amino, Azido, Bromo, or Cyano Groups. Tetrahedron Letters 1988, 29 (44), 5593-5594. https://doi.org/10.1016/S0040-4039(00)80820-5.
(16) Xu, F. J.; Kang, E. T.; Neoh, K. G. UV-Induced Coupling of 4-Vinylbenzyl Chloride on Hydrogen-Terminated Si(100) Surfaces for the Preparation of Well-Defined Polymer-Si Hybrids via Surface-Initiated ATRP. Macromolecules 2005, 38 (5), 1573-1580. https://doi.org/10.1021/ma049225a.
(17) Yu, W. H.; Kang, E. T.; Neoh, K. G.; Zhu, S. Controlled Grafting of Well-Defined Polymers on Hydrogen-Terminated Silicon Substrates by Surface-Initiated Atom Transfer Radical Polymerization. 2003. https://doi.org/10.1021/jp034330s.
(18) Buriak, J. M. Organometallic Chemistry on Silicon and Germanium Surfaces. 2002. https://doi.org/10.1021/cr000064s.
(19) Stewart, M. P.; Buriak, J. M. Photopatterned Hydrosilylation on Porous Silicon. Angewandte Chemie—International Edition 1998, 37 (23), 3257-3260. https://doi.org/10.1002/(SICI)1521-3773(19981217)37:23<3257::AID-ANIE3257>3.0.CO;2-1.
(20) Huck, L. A.; Buriak, J. M. UV-Initiated Hydrosilylation on Hydrogen-Terminated Silicon (111): Rate Coefficient Increase of Two Orders of Magnitude in the Presence of Aromatic Electron Acceptors. 2012. https://doi.org/10.1021/la3035819.
(21) Effenberger, F.; Götz, G.; Bidlingmaier, B.; Wezstein, M. Photoactivated Preparation and Patterning of Self-Assembled Monolayers with 1-Alkenes and Aldehydes on Silicon Hydride Surfaces. Angewandte Chemie—International Edition 1998, 37 (18), 2462-2464. https://doi.org/10.1002/(SICI)1521-3773(19981002)37:18<2462::AID-ANIE2462>3.0.CO;2-R.
(22) Terry, J.; Mo, R.; Wigren, C.; Cao, R.; Mount, G.; Pianetta, P.; Linford, M. R.; Chidsey, C. E. D. Reactivity of the H—Si (111) Surface. Nuclear Instruments and Methods in Physics Research, Section B: Beam Interactions with Materials and Atoms 1997, 133 (1-4), 94-101. https://doi.org/10.1016/S0168-583X(97)00467-9.
(23) Cicero, R. L.; Linford, M. R.; Chidsey, C. E. D. Photoreactivity of Unsaturated Compounds with Hydrogen-Terminated Silicon(111). Langmuir 2000, 16 (13), 5688-5695. https://doi.org/10.1021/la9911990.
(24) Nguyen, A. T.; Baggerman, J.; Paulusse, J. M. J.; Zuilhof, H.; van Rijn, C. J. M. Bioconjugation of Protein-Repellent Zwitterionic Polymer Brushes Grafted from Silicon Nitride. Langmuir 2012, 28 (1), 604-610. https://doi.org/10.1021/la2031363.
(25) Nguyen, A. T.; Baggerman, J.; Paulusse, J. M. J.; van Rijn, C. J. M.; Zuilhof, H. Stable Protein-Repellent Zwitterionic Polymer Brushes Grafted from Silicon Nitride. Langmuir 2011, 27 (6), 2587-2594. https://doi.org/10.1021/la104657c.
(26) Sano, H.; Maeda, H.; Ichii, T.; Murase, K.; Noda, K.; Matsushige, K.; Sugimura, H. Alkyl and Alkoxyl Monolayers Directly Attached to Silicon: Chemical Durability in Aqueous Solutions. Langmuir 2009, 25 (10), 5516-5525. https://doi.org/10.1021/la804080g.
(27) Bhairamadgi, N. S.; Pujari, S. P.; Trovela, F. G.; Debrassi, A.; Khamis, A. A.; Alonso, J. M.; al Zahrani, A. A.; Wennekes, T.; Al-Turaif, H. A.; van Rijn, C.; Alhamed, Y. A.; Zuilhof, H. Hydrolytic and Thermal Stability of Organic Monolayers on Various Inorganic Substrates. Langmuir 2014, 30 (20), 5829-5839. https://doi.org/10.1021/la500533f.
(28 Arshavsky-Graham, S.; Massad-Ivanir, N.; Segal, E.; Weiss, S. Porous Silicon-Based Photonic Biosensors: Current Status and Emerging Applications. 2018. https://doi.org/10.1021/acs.analchem.8b05028.
(29) Bã, M.-J.; Puchades, R.; Maquieira, Á. Chemical Surface Modifications for the Development of Silicon-Based Label-Free Integrated Optical (IO) Biosensors: A Review. Analytica Chimica Acta 2013, 777, 1-16. https://doi.org/10.1016/j.aca.2013.01.025.
(30) Lowe, B. M.; Sun, K.; Zeimpekis, I.; Skylaris, C.-K.; Green, N. G. Analyst CRITICAL REVIEW Field-Effect Sensors-from PH Sensing to Biosensing: Sensitivity Enhancement Using Streptavidin-Biotin as a Model System †. Analyst 2017, 142, 4173. https://doi.org/10.1039/c7an00455a.
(31) Chaki, N. K.; Vijayamohanan, K. Self-Assembled Monolayers as a Tunable Platform for Biosensor Applications; 2002; Vol. 17.
(32) Mooney, J. F.; Huntt, A. J.; Mcintosht, J. R.; Liberkot, C. A.; Walbat, D. M.; Rogers, C. T.; Prescott, D. M. Patterning of Functional Antibodies and Other Proteins by Photolithography of Silane Monolayers (Self-Assembled Monolayers/Biotin/Streptavidin/Adsorption Isotherms); 1996; Vol. 93.
(33) Williams, E. H.; Davydov, A. v; Motayed, A.; Sundaresan, S. G.; Bocchini, P; Richter, L. J.; Stan, G.; Steffens, K.; Zangmeister, R.; Schreifels, J. A.; Rao, V. Immobilization of Streptavidin on 4H—SiC for Biosensor Development. Applied Surface Science 2012, 258, 6056-6063. https://doi.org/10.1016/j.apsusc.2012.02.137.
(34) Albuszis, M.; Roth, P. J.; Exnowitz, F.; Wong, D. L; Pauer, W.; Moritz, H. U. Synthesis and In-Depth Characterization of Reactive, Uniform, Crosslinked Microparticles Based on Free Radical Copolymerization of 4-Vinylbenzyl Azide. Polymer Chemistry 2016, 7 (5), 1168-1180. https://doi.org/10.1039/c5py01848j.
(35) Zill, A. T.; Licha, K.; Haag, R.; Zimmerman, S. C. Synthesis and Properties of Fluorescent Dyes Conjugated to Hyperbranched Polyglycerols. New Journal of Chemistry 2012, 36 (2), 419-427. https://doi.org/10.1039/c1nj20476a.
(36) Darroudi, M.; Sarrafi, Y.; Hamzehloueian, M. An Efficient Synthesis of Novel Triazoles Incorporating Barbituric Motifs via [3+2] Cycloaddition Reactions: An Experimental and Theoretical Study. Journal of the Serbian Chemical Society 2018, 83 (7-8), 821-835. https://doi.org/10.2298/JSC170618038D.
(37) Li, S. X.; Feng, L. R.; Guo, X. J.; Zhang, Q. Application of Thermal Azide-Alkyne Cycloaddition (TAAC) Reaction as a Low Temperature Cross-Linking Method in Polymer Gate Dielectrics for Organic Field-Effect Transistors. Journal of Materials Chemistry C 2014, 2 (18), 3517-3520. https://doi.org/10.1039/c4tc00116h.
(38) Albuszis, M.; Roth, P. J.; Pauer, W.; Moritz, H. U. Two in One: Use of Azide Functionality for Controlled Photo-Crosslinking and Click-Modification of Polymer Microspheres. Polymer Chemistry 2016, 7 (34), 5414-5425. https://doi.org/10.1039/c6py00937a.

(39) Collman, J. P.; Devaraj, N. K.; Eberspacher, T. P. A.; Chidsey, C. E. D. Mixed Azide-Terminated Monolayers: A Platform for Modifying Electrode Surfaces. 2006. https://doi.org/10.1021/la052947q.
(40) Oesterhelt, F.; Rief, M.; Gaub, H. E. Single Molecule Force Spectroscopy by AFM Indicates Helical Structure of Poly(Ethylene-Glycol) in Water. New Journal of Physics 1999, 1 (1), 6. https://doi.org/10.1088/1367-2630/1/1/006.
(41) Harder, P.; Grunze, M.; Dahint, R.; Whitesides, G. M.; Laibinis, P. E. Molecular Conformation in Oligo(Ethylene Glycol)-Terminated Self-Assembled Monolayers on Gold and Silver Surfaces Determines Their Ability To Resist Protein Adsorption; 1998.
(42) Tokumitsu, S.; Liebich, A.; Herrwerth, S.; Eck, W.; Himmelhaus, M.; Grunze, M. Grafting of Alkanethiol-Terminated Poly(Ethylene Glycol) on Gold. Langmuir 2002, 18 (23), 8862-8870. https://doi.org/10.1021/la0258953.
(43) Zhu, X. Y.; Jun, Y.; Staarup, D. R.; Major, R. C.; Danielson, S.; Boiadjiev, V.; Gladfelter, W. L.; Bunker, B. C.; Guo, A. Grafting of High-Density Poly(Ethylene Glycol) Monolayers on Si(111). Langmuir 2001, 17 (25), 7798-7803. https://doi.org/10.1021/la010672i.
(44) Papra, A.; Gadegaard, N.; Larsen, N. B. Characterization of Ultrathin Poly(Ethylene Glycol) Monolayers on Silicon Substrates. 2001. https://doi.org/10.1021/la000609d.
(45) Pigorsch, E. Spectroscopic Characterisation of Cationic Quaternary Ammonium Starches. Starch-Stärke 2009, 61 (3-4), 129-138. https://doi.org/10.1002/star.200800090.
(46) Sánchez, J.; Rivas, B. L. Cationic Hydrophilic Polymers Coupled to Ultrafiltration Membranes to Remove Chromium (VI) from Aqueous Solution. Desalination 2011, 279 (1-3), 338-343. https://doi.org/10.1016/j.desal.2011.06.029.
(47) Palacio, D. A.; Rivas, B. L.; Urbano, B. F. Ultrafiltration Membranes with Three Water-Soluble Polyelectrolyte Copolymers to Remove Ciprofloxacin from Aqueous Systems. Chemical Engineering Journal 2018, 351, 85-93. https://doi.org/10.1016/j.cej.2018.06.099.
(48) Loubaki, E.; Ourevitch, M.; Sicsic, S. Chemical Modification of Chitosan by Glycidyl Trimethylammonium Chloride. Characterization of Modified Chitosan by 13C- and 1H-NMR Spectroscopy. European Polymer Journal 1991, 27 (3), 311-317. https://doi.org/10.1016/0014-3057(91)90111-Z.
(49) Sajomsang, W; Gonil, P.; Tantayanon, S. Antibacterial Activity of Quaternary Ammonium Chitosan Containing Mono or Disaccharide Moieties: Preparation and Characterization. International Journal of Biological Macromolecules 2009, 44 (5), 419-427. https://doi.org/10.1016/j.ijbiomac.2009.03.003.
(50) Socrates, G. Infrared and Raman Characteristic Group Frequencies: Tables and Charts, 3rd ed .; John Wiley & Sons Ltd: Chichester, 2001.
(51) Collman, J. P.; Devaraj, N. K.; Eberspacher, T. P. A.; Chidsey, C. E. D. Mixed Azide-Terminated Monolayers: A Platform for Modifying Electrode Surfaces. Langmuir 2006, 22 (6), 2457-2464. https://doi.org/10.1021/la052947q.
(52) Vos, R.; Rolin, C.; Rip, J.; Conard, T.; Steylaerts, T.; Cabanilles, M. V.; Levrie, K.; Jans, K.; Stakenborg, T. Chemical Vapor Deposition of Azidoalkylsilane Monolayer Films. Langmuir 2018, 34 (4), 1400-1409. https://doi.org/10.1021/acs.langmuir.7b04011.
(53) Gouget-Laemmel, A. C.; Yang, J.; Lodhi, M. A.; Siriwardena, A.; Aureau, D.; Boukherroub, R.; Chazalviel, J. N.; Ozanam, F.; Szunerits, S. Functionalization of Azide-Terminated Silicon Surfaces with Glycans Using Click Chemistry: XPS and FTIR Study. Journal of Physical Chemistry C 2013, 117 (1), 368-375. https://doi.org/10.1021/jp309866d.

### Supporting Information:

### Dual Zwitterionic Alkyne Experiments

Synthesis Procedure for 1,4-Bis(dimethylamino)-2-butyne

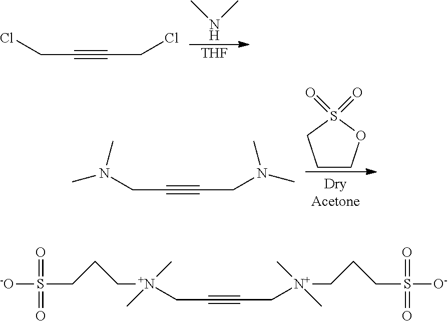

This synthesis based upon the following citations.¹⁻³

A three-neck flask was equipped with a reflux condenser, drop funnel, and stir bar as seen below. The third neck of the RB flask was sealed via glass stopper. This apparatus was then purged with nitrogen for at least 30 minutes with the nitrogen entering through the top of the condenser, flowing through the 3-neck flask, and exiting through the top of the drop funnel. The nitrogen source line contained a “Y” adapter before the condenser inlet for connection of a bubbler for maintaining a nitrogen atmosphere throughout the following reaction steps. After the nitrogen purge, a septum was placed over the drop-funnel, and the valve of the drop-funnel was then closed. Nitrogen flow was slowed to approximately 1-2 bubbles per second through the bubbler upon sealing of the drop funnel. The reflux condenser was then chilled using a cooled water circulator/pump containing a 50/50 mix of water and ethylene glycol. This cooling solution for the condenser was maintained at −15° C. (This subzero coolant temperature is to condense the volatile dimethyl amine and prevent its loss from reaction apparatus.) Simultaneously the RB flask was pre-chilled via ice bath. Once chilled, 76.5 mL of the 2M dimethylamine/THF solution (0.153 mol of dimethylamine) was added into the RB flask through the 3^{rd} neck and re-sealed via glass stopper. A solution of 3 mL (0.031 mol) of 1,4-dichloro-2-butyne in 20 mL of THF was prepared and injected into the drop funnel via syringe. With stirring and over the ice bath, the 1,4-dichloro-2-butyne solution was dispensed from the drop funnel over the course of 30 minutes. This was allowed to react for 4 hours while chilled via ice bath. The ice bath was then removed and the mixture was allowed to reach room temperature and react for an additional 16 hours. The solution was then slowly heated (at a rate of approx. 10° C. per hour) to THF reflux and allowed to react at reflux for 1 hour. The reaction mixture was allowed to cool back to room temperature, and the THF was removed via rotary evaporation. The remaining contents of the flask were re-dissolved in 50 mL of diethyl ether. This was poured over an aqueous solution of KOH (10 g in 50 mL water) in a separatory funnel. After phase separation, the lower aqueous phase was collected and set aside. The upper ether phase was then collected. The aqueous phase was then washed 4 times with diethyl ether (25 mL each) and then all of the ether extracts were combined. The combined ether extracts were dried over K₂CO₃ for at least 30 minutes. The diethyl ether was removed via rotary evaporation. The product was collected with 2.574 g recovered (59.2% yield).

Reaction of 1,4-Bis(dimethylamino)-2-butyne with 1,3-Propane Sultone

To a RB flask, 2.22 g (15.8 mmol) of 1,4-bis(dimethylamino)-2-butyne was added and dissolved in 10 mL of dry acetone. In a separate flask, 4.25 g (34.8 mmol) of 1,3-propane sultone (1,3-PS) was added and dissolved in 15 mL of dry acetone. Both flasks were sealed and sparged with nitrogen. The 1,3-PS solution was then transferred via cannula to the first solution over the course of 30 minutes with stirring. This was allowed to react for 24 hours at room temperature. The product was collected via filtration, rinsed with an excess of acetone, and dried under vacuum. The product was collected with 4.25 g recovered (70.1% yield).

### REFERENCES FOR SUPPORTING INFORMATION

(1) Barton, D. H. R.; Dawes, C. C.; Franceschi, G.; Foglio, M.; Ley, S. v; Magnus, P. D.; Mitchell, W. L.; Temperelli, A. A New Synthetic Approach towards Adriamycin; 1980.
(2) Brandsma, L. Preparative Acetylenic Chemistry., 2nd ed .; Elsevier Science, 1988.
(3) Brandsma, L.; Verkruijsse, H. D. Synthesis of Acetylenes, Allenes and Cumulenes. In Synthesis of Acetylenes, Allenes and Cumulenes; Elsevier: Amsterdam, 1981. https://doi.org/10.1016/b978-0-12-125751-4.x5000-0.

It should be noted that ratios, concentrations, amounts, and other numerical data may be expressed herein in a range format. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a concentration range of “about 0.1% to about 5%” should be interpreted to include not only the explicitly recited concentration of about 0.1 wt % to about 5 wt %, but also include individual concentrations (e.g., 1%, 2%, 3%, and 4%) and the sub-ranges (e.g., 0.5%, 1.1%, 2.2%, 3.3%, and 4.4%) within the indicated range. In an embodiment, the term “about” can include traditional rounding according to significant figures of the numerical value. In addition, the phrase “about ‘x’ to ‘y’” includes “about ‘x’ to about ‘y’”.

It should be emphasized that the above-described embodiments of the present disclosure are merely possible examples of implementations, and are set forth only for a clear understanding of the principles of the disclosure. Many variations and modifications may be made to the above-described embodiments of the disclosure without departing substantially from the spirit and principles of the disclosure. All such modifications and variations are intended to be included herein within the scope of this disclosure.

1. A method of attaching an organic azide to a H-terminated group, comprising
contacting a solution including the organic azide with the H-terminated group; and
exposing the organic azide and the H-terminated group to an energy source, a catalyst or a combination of the energy source and the catalyst, wherein the exposure results in the formation of a covalent bond between the organic azide and the H-terminated group to form a moiety including an azide.

2. The method of claim 1, wherein the H-terminated group is a H-terminated surface of a structure, wherein the exposure results in the formation of a covalent bond between the organic azide and the surface to form the moiety including the azide, wherein the moiety is attached to the surface.

3. The method of claim 1, wherein the H-terminated group is a H-terminated group of a molecule.

4. The method of claim 3, wherein the molecule is a soluble molecule.

5. The method of claim 3, wherein the molecule is a polymer.

6. The method of claim 5, wherein the polymer is a soluble polymer.

7. The method of claim 1, wherein the organic azide has one of the following structures: 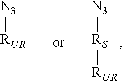
wherein R_{S} is a bivalent, substituted or unsubstituted, linear or branched aliphatic group, a bivalent, substituted or unsubstituted, linear or branched hetero-carbon group, a bivalent, substituted or unsubstituted, carbocyle group, or a bivalent, substituted or unsubstituted, heterocyclo group, and wherein R_{UR} is an unsaturated reactive group that reacts to form a covalent bond between the organic azide and the H-terminated group, optionally wherein R_{UR} is an alkenyl group, an alkynyl group, a carbonyl group, a ketone group, an aldehyde group, a nitrile group, or an imine group.

8. The method of claim 1, wherein the organic azide has the following structure: 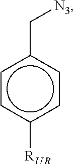
wherein R_{UR} is an alkenyl group, an alkynyl group, a carbonyl group, a ketone group, an aldehyde group, a nitrile group, or an imine group.

9. The method of claim 1, wherein the organic azide has one of the following structures: 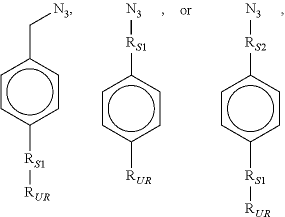
wherein R_{UR} is an alkenyl group, an alkynyl group, a carbonyl group, a ketone group, an aldehyde group, a nitrile group, or an imine group, and wherein R_{S}, R_{S1}, and R_{S2} are each independently selected from a bivalent, substituted or unsubstituted, linear or branched, aliphatic group, a bivalent, substituted or unsubstituted, linear or branched, hetero-carbon group, a bivalent, substituted or unsubstituted, carbocyle group, or a bivalent, substituted or unsubstituted, heterocyclo group.

10. The method of claim 1, wherein the moiety including the azide is formed from one of the following structures: 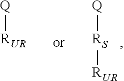
wherein Q is a halide or leaving group that is characterized in that it can be converted to an azide group, wherein R_{S} is a bivalent, substituted or unsubstituted, linear or branched aliphatic group, a bivalent, substituted or unsubstituted, linear or branched, hetero-carbon group, a bivalent, substituted or unsubstituted, carbocyle group, or a bivalent, substituted or unsubstituted, heterocyclo group, and wherein R_{UR} is an alkenyl group, an alkynyl group, a carbonyl group, a ketone group, an aldehyde group, a nitrile group, or an imine group, optionally, wherein the method includes reacting Q to form the moiety including the azide, optionally wherein Q is an alkyl halide, a benzyl halide, an aryl halide, or a sulfonate ester.

11-12. (canceled)

13. The method of claim 2, wherein the H-terminated surface is a H-terminated silicon surface, wherein there is a silicon-carbon bond formed between the surface and the moiety including the azide; or wherein the H-terminated surface is a H-terminated silicon surface, wherein there is a silicon-nitrogen bond formed between the surface and the moiety including the azide; or wherein the H-terminated surface is a H-terminated silicon surface, wherein there is a silicon-oxygen bond formed between the surface and the moiety including the azid.

14-30. (canceled)

31. The method of claim 1, wherein the organic azide is a polymer, wherein the polymer includes at least one azide group and at least one unsaturated reactive group (R_{UR}), where R_{UR} is configured to react to form the covalent bond between the organic azide and the H-terminated group, optionally wherein R_{UR} is an alkenyl group, an alkynyl group, a carbonyl group, a ketone group, an aldehyde group, a nitrile group, or an imine group.

32. The method of claim 1, wherein the organic azide includes at least one azide group and at least one unsaturated reactive group (R_{UR}), where R_{UR} is configured to react to form the covalent bond between the organic azide and the H-terminated group, optionally wherein R_{UR} is an alkenyl group, an alkynyl group, a carbonyl group, a ketone group, an aldehyde group, a nitrile group, or an imine group.

33. (canceled)

34. A material comprising:
a structure having a surface, wherein the surface includes structural surface Si atoms, wherein at least one structural surface Si is covalently bonded to a carbon of a moiety including an azide or wherein at least one structural surface Si is covalently bonded to a nitrogen of a moiety including an azide or wherein at least one structural surface Si is covalently bonded to an oxygen of a moiety including an azide.

35. The material of claim 34, wherein the carbon of the moiety is part of a molecule covalently bonded to the azide; or wherein the nitrogen of the moiety is part of a molecule covalently bonded to the azide; or wherein the oxygen of the moiety is part of a molecule covalently bonded to the azide.

36-37. (canceled)

38. The material of claim 34, wherein the azide is bonded to an R_{S} group, wherein the R_{S} group is a bivalent, substituted or unsubstituted, linear or branched hydrocarbon group, a bivalent, substituted or unsubstituted, linear or branched hetero-hydrocarbon group, a bivalent, substituted or unsubstituted, cycloalkyl group, or a bivalent, substituted or unsubstituted, cycloheteroalkyl group.

39. The material of claim 34, wherein covalent bond between structural surface Si and the carbon, nitrogen, or oxygen of a moiety including an azide is the reaction product of R_{UR} with a structural surface Si—H group of the structure, wherein R_{UR} is an alkenyl group, an alkynyl group, a carbonyl group, a ketone group, an aldehyde group, a nitrile group, or an imine group.

40. The material of claim 34, wherein the at least one structural surface Si is covalently bonded to the carbon, nitrogen, or oxygen of the moiety including the azide formed by the reaction of a structural surface Si—H group of the structure with an organic azide having one of the following structures: 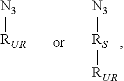
wherein R_{S} is a bivalent, substituted or unsubstituted, linear or branched, aliphatic group, a bivalent, substituted or unsubstituted, linear or branched, hetero-carbon group, a bivalent, substituted or unsubstituted, carbocyle group, or a bivalent, substituted or unsubstituted, heterocyclo group, and wherein R_{UR} is an unsaturated reactive group that reacts to form the covalent bond between the organic azide and the surface, optionally wherein R_{UR} is an alkenyl group, an alkynyl group, a carbonyl group, a ketone group, an aldehyde group, a nitrile group, or an imine group.

41. The material of claim 40, wherein the organic azide has the following structure: 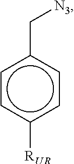
wherein R_{UR} is an alkenyl group, an alkynyl group, a carbonyl group, a ketone group, an aldehyde group, a nitrile group, or an imine group.

42. The material of claim 40, wherein the organic azide has one of the following structure: 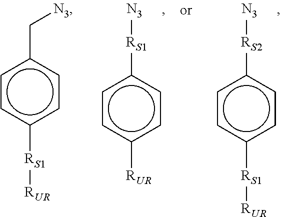
wherein R_{UR} is an alkenyl group, an alkynyl group, a carbonyl group, a ketone group, an aldehyde group, a nitrile group, or an imine group, and wherein R_{S}, R_{S1}, and R_{S2} are each independently selected from a bivalent, substituted or unsubstituted, linear or branched, aliphatic group, a bivalent, substituted or unsubstituted, linear or branched, hetero-carbon group, a bivalent, substituted or unsubstituted, carbocyle group, or a bivalent, substituted or unsubstituted, heterocyclo group.

43-44. (canceled)
